(19) United States
(12) Patent Application Publication
(10) Pub. No.: US 2026/0277965 A1
(43) Pub. Date: Sep. 17, 2026

(54) MULTI-AGENT LLM NARRATIVE GENERATION ARCHITECTURE

(71) Applicants: ORACLE INTERNATIONAL CORPORATION, Redwood Shores, CA (US); ORACLE FINANCIAL SERVICES SOFTWARE LIMITED, Mumbai (IN)

(72) Inventors: Steffen BACKMANN, Zurich (CH); Soo Min LEE, Zurch (CH); Cosimo FEDELI, Grizzana Morandi (IT); Govind GOPINATHAN NAIR, Jersey City, NJ (US); Jason Paul SOMRAK, North Royalton, OH (US); Hesam FATHI MOGHADAM, Sunnyvale, CA (US)

(21) Appl. No.: 19/382,597

(22) Filed: Nov. 7, 2025

Related U.S. Application Data
(60) Provisional application No. 63/770,830, filed on Mar. 12, 2025.

(51) Int. Cl. G06F 16/3332; G06F 16/35

(52) U.S. Cl. CPC G06F 16/3338; G06F 16/35

(57) ABSTRACT

Systems, methods, and other embodiments associated with automated case narrative generation are described. In one embodiment, a system generates, by a generation agent, an event narrative draft from case data associated with alerted interactions. The system parses, by a pattern detector agent, the event narrative draft to automatically identify candidate statements that aggregate or generalize the case data. The system distributes, by a master evaluator agent the candidate statements to pattern checking agents for evaluation for correctness. The system executes, by the pattern checking agents, a programmatic, LLM-based validation of individual candidate statements to classify the individual candidate statements as consistent or inconsistent with the interaction records. The system combines, by the master evaluator agent executed by the computing system, the validated statements from the one or more pattern checking agents into a final event narrative based on the corrected statements.

### CROSS REFERENCE TO RELATED APPLICATIONS

This disclosure claims the benefit of U.S. Provisional Patent Application Ser. No. 63/770,830 filed Mar. 12, 2025, titled “AUTOMATED ANTI-MONEY LAUNDERING CASE NARRATIVE GENERATION”, inventors: Steffen BACKMANN, Soo Min LEE, Cosimo FEDELI, Govind GOPINATHAN NAIR, Jason Paul SOMRAK, and Hesam FATHI MOGHADAM, and assigned to the present assignee, which is incorporated by reference herein in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Existing automated reporting approaches often rely on deterministic rule engines or simple text generation, which suffer from significant drawbacks. These systems may generate outputs that are incomplete, inconsistent across cases, or factually inaccurate when applied to complex transaction data. Current large language model (LLM) approaches in this space are also prone to producing content that cannot be verified against source data, creating reliability concerns. As a result, prior systems struggle to deliver outputs that are accurate, explainable, and reproducible at scale.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates, in a system block diagram, one embodiment of a narrative generation system that is associated with automated case narrative generation for monitoring systems.

FIG. 2 illustrates, in a process flow diagram, one embodiment of a narrative generation method that is associated with automated case narrative generation for monitoring systems.

FIG. 3 illustrates an example narrative generation system 300 that is associated with use of AI agents to automate case narrative generation for monitoring systems.

FIG. 4 illustrates an embodiment of a computing system configured with the example systems and/or methods disclosed.

### DETAILED DESCRIPTION

Systems, methods, and other embodiments are described herein that provide automated case narrative generation for monitoring systems, such as those used for monitoring transactions. In one embodiment, a narrative generation system uses coordinated large language model agents together to automatically generate factually reliable narratives from transaction monitoring data. For example, the narrative generation system overcomes the inaccuracy and unverifiability of prior automated reporting systems by implementing a multi-agent AI framework that generates narratives in stages and applies deterministic validation to ensure consistency with source data. In this way, the narrative generation system divides the task of generating case narratives from case data among specialized AI agents and incrementally validating their outputs for accuracy.

Unlike prior systems that generate unverified text, the narrative generation system structures narrative creation into multiple coordinated steps that improve factual reliability. A generation agent drafts the narrative from case records, alerts, and entity data. A pattern detector agent then automatically identifies only those statements that summarize or generalize the data—the kinds of statements most prone to errors. These statements are checked in parallel by multiple automated review agents (referred to as pattern checking agents), each performing a programmatic comparison with the underlying records. Their outputs are resolved by a master evaluator agent through a majority voting process, and the corrected statements are compiled into the final narrative. This staged, multi-agent approach provides a novel way to reduce hallucinations and enforce consistency between the narrative and the transaction data.

### Example Improvements Provided by Narrative Generation System

The narrative generation system provides a number of technical advantages over prior approaches for producing event narratives and case reports.

Improved reliability through modularity. Existing narrative generation approaches often rely on a single model that produces inconsistent and error-prone results. The narrative generation system improves reliability by dividing the process into discrete stages of drafting, pattern detection, evaluation, correction, and final compilation. This improvement is accomplished by implementing multiple coordinated agents, each specialized for a distinct stage of processing.

Targeted evaluation of high-risk content. Prior systems waste computing effort on verifying deterministic content and fail to focus on error-prone generalizations. The narrative generation system improves efficiency by automatically identifying candidate statements that summarize or generalize case data. This improvement is accomplished by a pattern detector agent that parses draft narratives to flag those statements that need factual verification.

Programmatic data validation. Large language models used in isolation often hallucinate or misreport facts, producing unreliable narratives. The narrative generation system mitigates hallucinations by programmatically comparing candidate statements against structured case data and deterministic tool outputs to determine consistency with them. In one embodiment, this improvement is accomplished through deterministic auxiliary tools that generate analytic results such as counts, totals, ranges, and dates, which are used to validate narrative content.

Stability through majority voting. Conventional evaluation methods are sensitive to stochastic model variability inherent in LLMs, leading to inconsistent outcomes. The narrative generation system improves stability by running multiple evaluations of candidate statements and applying a majority voting procedure. This improvement is accomplished by configuring the master evaluator agent to collect outputs from multiple pattern checking agents and resolve disagreements using a voting mechanism.

Integration of deterministic tools with probabilistic models. LLM-only approaches are weak at handling precise numerical information such as sums or date ranges. The narrative generation system improves factual accuracy by integrating deterministic auxiliary tools with LLM-based narrative drafting. This improvement is accomplished by enforcing inclusion of verified analytic outputs in narrative drafts and correcting omissions during evaluation.

Task-specific agent specialization. Using a single large model for all processing stages is computationally expensive and inefficient. The narrative generation system improves cost-performance balance by assigning different models to different tasks, with lighter-weight models for drafting and stronger models for evaluation. This improvement is accomplished by dynamically configuring model selection and hyperparameters to suit each agent's role.

Enhanced explainability. Conventional narrative generation systems provide little transparency into how conclusions are derived, limiting auditability. The narrative generation system improves explainability by associating extracted statements with specific source data and recording their evaluation outcomes. This improvement is accomplished by retaining pattern extractions, evaluation results, and corrections as linked artifacts for review.

Bottom-up construction of reports. Direct generation of case-level reports often propagates errors and misses context. The narrative generation system improves accuracy by first generating and validating event-level narratives, which are then collated into a complete case report. This improvement is accomplished by organizing workflow such that event narratives serve as validated building blocks for case reports.

Retention of intermediate narratives. Prior systems discard intermediate steps, reducing transparency and reuse. The narrative generation system improves utility by retaining validated event-level narratives in addition to case-level reports. This improvement is accomplished by storing and outputting both intermediate and final narratives for use in investigations.

Programmatic enforcement of tool outputs. Narrative drafts often omit critical numerical details such as totals or time ranges. The narrative generation system improves completeness by ensuring tool-generated summaries appear in the narrative text. This improvement is accomplished by programmatically checking narrative drafts for inclusion of tool outputs and correcting omissions during evaluation.

Error isolation and correction. Conventional systems require full regeneration of narratives to fix individual errors, leading to inefficiency and potential new mistakes. The narrative generation system improves efficiency by isolating and correcting only those statements identified as inaccurate. This improvement is accomplished by applying corrections at the statement level during the master evaluator agent's review.

Scalability of compliance review. Manual review of large volumes of alerts requires significant human resources and does not scale. The narrative generation system improves scalability by automating verification and correction of narrative content. This improvement is accomplished by substituting automated agents for repetitive validation tasks that otherwise burden investigators.

Consistency across cases. Manually written or LLM-only narratives vary in style and content, creating inconsistency. The narrative generation system improves consistency by promoting a uniform structure and style across generated narratives. This improvement is accomplished by using standardized templates, examples, and evaluation criteria in each generation stage.

Improved factual reliability. Traditional narrative systems cannot guarantee consistency between text and source data. The narrative generation system improves factual reliability by validating and correcting narrative content against structured records. This improvement is accomplished by cross-checking candidate statements against deterministic auxiliary outputs and retaining only verified content.

Optimized computing resource usage. Running large models across all tasks wastes computational resources. The narrative generation system improves resource efficiency by allocating lightweight models to simpler drafting stages and reserving heavier models for complex evaluation. This improvement is accomplished by configuring the workflow to employ different models and hyperparameters suited to the computational demands of each stage.

No action or function described or claimed herein is performed by the human mind. An interpretation that any action or function can be performed in the human mind is inconsistent with and contrary to this disclosure.

### Example Narrative Generation System

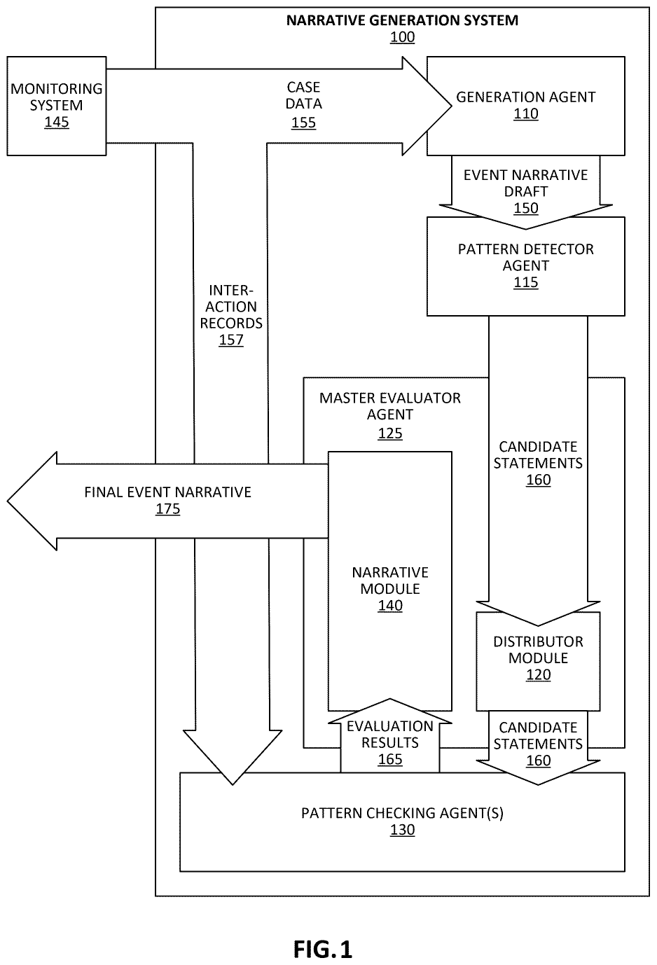

FIG. 1 illustrates one embodiment of a narrative generation system 100 that is associated with automated case narrative generation for monitoring systems. The narrative generation system 100 processes transaction monitoring data through coordinated AI agents to automatically produce factually reliable event narratives. Narrative generation system 100 has various components, including a generation agent 110, a pattern detector agent 115, a distributor module 120 of a master evaluator agent 125, a pattern checking agent(s) 130, and a narrative module 140 of master evaluator agent 125. Narrative generation system 100 receives case data from an interaction monitoring system 145, such as a financial transaction monitoring system. In one embodiment, the components of narrative generation system 100 and interaction monitoring system 145 intercommunicate in a network computing system, for example by electronic messages, as discussed below under the heading “Cloud or Enterprise Embodiments.” The components of narrative generation system 100 are configured to make information that they generate available as output for downstream processing by one or more other components of narrative generation system 100.

In one embodiment, generation agent 110 is configured to generate an event narrative draft 150 based at least in part on case data 155 associated with alerted interactions from a monitoring system 145. The case data 155 includes interaction records 157 (structured entries representing transactions or activities flagged by the monitoring system), alert highlights (attributes that characterize key features of an alerted interaction), and entity information (structured data describing the parties involved in an alerted interaction). In one embodiment, pattern detector agent 115 is configured to parse the event narrative draft 150 to automatically identify one or more candidate statements 160 that aggregate or generalize the case data 155 in the event narrative draft 150. In one embodiment, distributor module 120 of master evaluator agent 125 is configured to distribute the one or more candidate statements 160 to one or more pattern checking agents 130 that correspond to the one or more patterns for evaluation for correctness.

In one embodiment, pattern checking agent(s) 130 is configured to execute a programmatic validation of individual candidate statements 160 against the interaction records 157. The programmatic validation operates to classify the individual candidate statements 160 as consistent with or inconsistent with the interaction records 157. For example, the programmatic validation may include prompting an LLM to validate the consistency of a candidate statement 160 with the interaction records 157.

In one embodiment, narrative module 140 of master evaluator agent 125 is configured to combine the evaluation results from the one or more pattern checking agents 130 into a final event narrative based on the corrected statements 170, wherein the final event narrative 175 exhibits improved factual reliability relative to the event narrative draft 150.

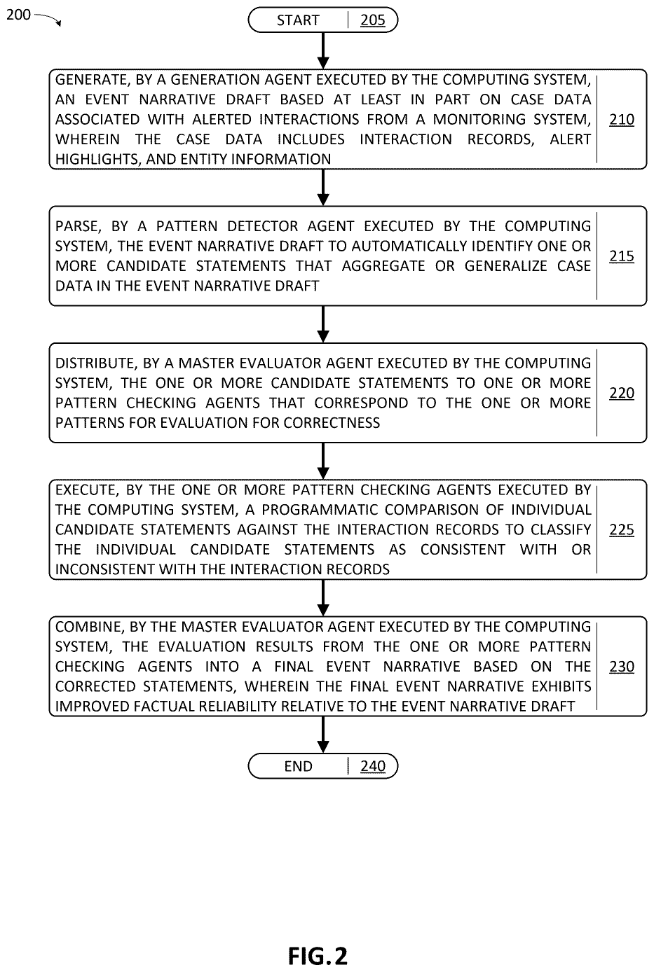

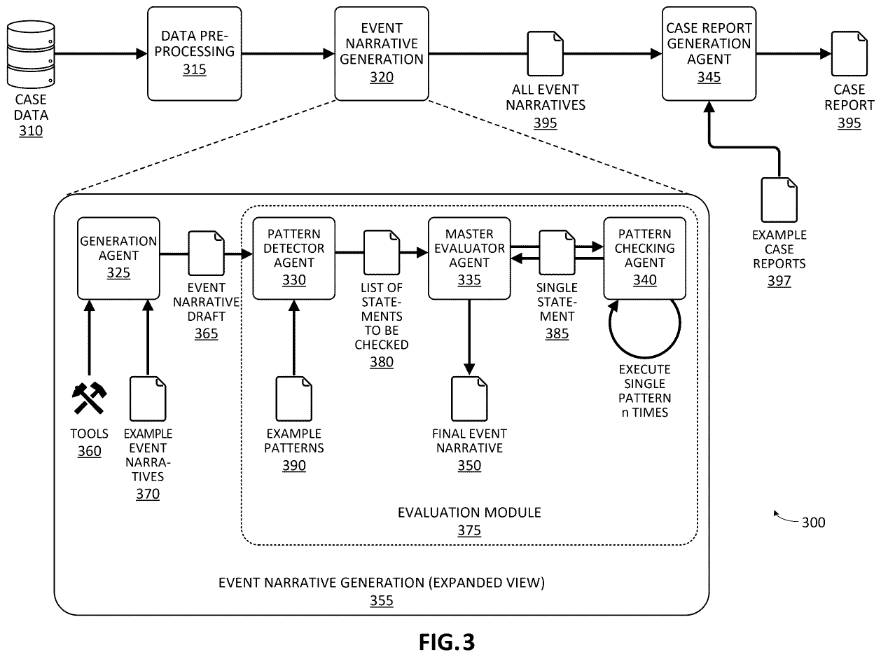

Further details regarding narrative generation system 100 are presented herein. In one embodiment, operations of narrative generation system 100 will be described with reference to narrative generation method 200 of FIG. 2. In one embodiment, an example implementation of narrative generation system 100 will be described with reference to example narrative generation system 300 of FIG. 3.

### Example Narrative Generation Method

FIG. 2 illustrates one embodiment of a narrative generation method 200 that is associated with automated case narrative generation for monitoring systems. In one embodiment, as a general overview, narrative generation system 100 carries out the narrative generation method 200 for generating reliable event narratives from transaction monitoring data. The system first employs a generation agent to produce an initial draft narrative based on case data, which includes interaction records, alert highlights, and entity details. This draft is then parsed by a pattern detector agent to automatically identify candidate statements that summarize or generalize information from the case data. The identified statements are distributed by a master evaluator agent to one or more pattern checking agents, each configured to evaluate whether the statements are factually supported by the underlying interaction records. Each pattern checking agent performs a programmatic validation of candidate statement against data, classifying the statement as consistent or inconsistent, and corrects those that are inconsistent. Finally, the master evaluator agent compiles the validated statements to produce a final event narrative with improved factual reliability.

In one embodiment, narrative generation method 200 initiates at START block 205 in response to narrative generation system 100 determining that one or more conditions or events have been detected or have occurred. The conditions or events for initiating narrative generation method 200, include, but are not limited to: (1) narrative generation system 100 has received an instruction to generate an event narrative from one or more alerted events; (2) narrative generation system 100 has received case data for one or more alerted events; (3) a user or administrator has initiated narrative generation method 200; (4) it is currently a time at which narrative generation method 200 is scheduled to be run; or (5) some other condition for commencing narrative generation method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of narrative generation system 100 executes narrative generation method 200. In one embodiment, at START block 205, narrative generation system 100 configures compute resources for performing narrative generation method 200. (1) narrative generation system 100 provisions (i.e., allocates and initializes) resources of the computing system that are used by narrative generation system 100, such as processor, memory and storage (for example, for executing components of narrative generation system 100). (2) narrative generation system 100 establishes access to one or more networks for the resources, such as access to (a) internal networks for communication among components of narrative generation system 100 and (b) external networks for communication with other computing systems (for example, client systems or monitoring system 145). (3) narrative generation system 100 connects to data sources (such as databases, data stores, file systems, and cloud storage) used by the narrative generation method 200. And, (4) narrative generation system 100 configures the computing system with system settings, software dependencies and libraries, and modules for executing the components of narrative generation system 100. Following initiation at START block 205, narrative generation method 200 proceeds to block 210.

At block 210, narrative generation method 200 generates an event narrative draft based at least in part on case data associated with alerted interactions from a monitoring system. The case data includes interaction records, alert highlights, and entity information. In one embodiment, the narrative generation system 100 employs a generation agent executed by the computing system to produce an event narrative draft based at least in part on case data associated with alerted interactions from a monitoring system. The event narrative draft is a machine-generated text object that summarizes the case data for a specific event and is formatted for later automated evaluation.

Narrative generation system 100 retrieves case data comprising interaction records, alert highlights, and entity information from a database of monitored interactions. The retrieved data is normalized by aligning field names and formats to a schema usable by the agent. Aggregation functions are then applied to compute summary statistics such as totals, counts, and ranges. The normalized data and summaries are provided as structured inputs to the generation agent. The generation agent executes a narrative generation process using prompt templates and prior examples to generate textual narrative content. The generated content is output as an event narrative draft and stored in system memory.

This step addresses the problem that prior systems output raw transaction logs or incomplete summaries without producing a structured narrative. The generation agent improves upon these approaches by creating a consistent text draft aligned with structured case data, reducing errors and omissions in subsequent processing. Unlike conventional systems, the narrative generation system converts raw monitoring data into a coherent narrative suitable for automated evaluation, thereby advancing system operation. The inclusion of interaction records, alert highlights, and entity information ensures that the generated narrative draft is complete and contextual. The system also detects conditions necessary for execution, including the presence of case data in the database and the completion state of the generation agent.

In one embodiment, narrative generation method 200 generates an event narrative draft based at least in part on case data associated with alerted interactions from a monitoring system as follows. The narrative generation system 100 retrieves case data comprising interaction records, alert highlights, and entity information from a monitoring database. The narrative generation system 100 normalizes the retrieved data by aligning field names and formats to a schema usable by the agent. The narrative generation system 100 applies aggregation functions to compute summary statistics such as totals, counts, and ranges. The narrative generation system 100 provides the normalized data and summaries as structured inputs to the generation agent. The generation agent executes a LLM-based narrative generation process using prompt templates and prior examples to generate textual narrative content. The generation agent outputs the generated content as an event narrative draft stored in system memory.

In one embodiment, the steps of block 210 are performed by generation agent 110. At the conclusion of block 210, narrative generation method 200 has transformed structured case data inputs into a textual event narrative draft output. Generation of the narrative draft converts the raw monitoring data into a natural language discussion of a granular event that is aligned with structured case data. Processing continues to block 215.

In summary, Step 210 transforms structured case data inputs into a textual event narrative draft output. Completion of this step provides a structured text narrative that converts raw monitoring data into a format usable for automated evaluation. This step provides a technical improvement over prior art by generating consistent narrative drafts aligned with structured case data, thereby improving reliability, accuracy, and scalability of downstream narrative processing.

At block 215, narrative generation method 200 parses the event narrative draft to automatically identify one or more candidate statements that aggregate or generalize case data in the event narrative draft. In one embodiment, the narrative generation system employs a pattern detector agent executed by the computing system to parse the event narrative draft and automatically identify the candidate statements. Candidate statements are text fragments drawn from the draft narrative that summarize, combine, or generalize information from interaction records, alert highlights, or entity details, and are distinguished from simple citations of raw data values.

The pattern detector loads the event narrative draft into memory and tokenizes the draft into sentences or semantic units. The pattern detector agent applies pattern recognition functions that detect linguistic or structural markers of aggregation or generalization. Examples include language that references trends, frequencies, or cross-record relationships. Each detected statement is extracted as a separate candidate statement object and enriched with surrounding context so that it may be evaluated independently. The resulting objects are stored for use by the master evaluator agent in subsequent processing.

Parsing the event narrative draft to automatically identify the particular candidate statements in need of validation overcomes the problem that prior systems treat all narrative content equally and waste computational resources verifying deterministic details that are already guaranteed by programmatic tools. By contrast, the narrative generation system isolates those statements most likely to contain factual inaccuracies, focusing verification efforts where they are needed. The identification of candidate statements ensures that only potentially error-prone narrative content is flagged for validation, which improves accuracy. The enrichment of candidate statements with contextual data allows each statement to be evaluated in isolation, thereby improving precision of the correctness checks.

In one embodiment, narrative generation method 200 parses the event narrative draft to automatically identify one or more candidate statements that aggregate or generalize case data in the event narrative draft as follows. The pattern detector agent loads the event narrative draft into memory. The pattern detector agent tokenizes the draft into sentences or semantic units. The pattern detector agent applies pattern recognition functions to detect language indicating aggregation or generalization. The pattern detector agent extracts each detected candidate statement as a separate data object. The pattern detector agent enriches candidate statements with surrounding context to make them self-contained for evaluation. The pattern detector agent stores the resulting candidate statement objects for use by the master evaluator agent.

In one embodiment, the steps of block 215 are performed by pattern detector agent 115. At the conclusion of block 215, narrative generation method 200 has transformed a raw event narrative draft into structured candidate statements suitable for correctness evaluation. This enables the narrative generation system to focus computational resources on the most error-prone narrative content, improving overall accuracy and efficiency Processing continues to block 220.

At block 220, narrative generation method 200 distributes the one or more candidate statements to one or more pattern checking agents that correspond to the one or more patterns for evaluation for correctness. In one embodiment, the narrative generation system employs a master evaluator agent executed by the computing system to distribute the candidate statements to one or more pattern checking agents that correspond to the patterns for correctness evaluation. As used herein, the term “distribute” refers to routing candidate statement objects, along with associated case data, to software modules configured to evaluate their factual consistency with interaction records and analytic tool outputs.

In one embodiment, the master evaluator agent retrieves candidate statement objects produced by the pattern detector agent and queues them in a distribution module. The master evaluator agent allocates each candidate statement to one or more pattern checking agents based on pre-defined evaluation rules or available computing resources. Candidate statements, along with the relevant case data, are transmitted to the assigned pattern checking agents. The routing of each candidate statement is recorded to ensure traceability of evaluation results.

In this way, the narrative generation system overcomes the problem that conventional systems attempt to evaluate entire narratives in a single pass, which limits scalability and increases error rates. The narrative generation system improves accuracy and throughput by distributing candidate statements to multiple independent checking agents that operate in parallel. The distribution of candidate statements enables scalable evaluation by dividing tasks among parallel checking agents. The traceability of routing ensures that evaluation results can be linked back to specific candidate statements, thereby maintaining accountability in the evaluation process.

In one embodiment, narrative generation method 200 distributes the one or more candidate statements to one or more pattern checking agents that correspond to the one or more patterns for evaluation for correctness as follows. The master evaluator agent: (1) retrieves candidate statement objects produced by the pattern detector agent; (2) queues the candidate statements in a task distribution module; (3) allocates each candidate statement to one or more pattern checking agents based on available compute resources or pre-defined evaluation rules; and transmits the candidate statements, along with associated case data, to the assigned pattern checking agents.

In one embodiment, the steps of block 220 are performed by distributor module 120 of master evaluator agent 125. At the conclusion of block 220, narrative generation method 200 has transformed the extracted candidate statements into routed evaluation tasks assigned to one or more pattern checking agents, thereby enabling distributed and traceable correctness evaluation. Processing continues to block 225.

At block 225, narrative generation method 200 executes a programmatic validation of individual candidate statements against the interaction records to classify the individual candidate statements as consistent with or inconsistent with the interaction records. In one embodiment, the narrative generation system employs one or more pattern checking agents executed by the computing system to semantically compare candidate statements against interaction records. Each candidate statement is then classified as consistent with (valid) or inconsistent with (invalid) the interaction records. As used herein, the term “programmatic validation” refers to computer-executed operations that evaluate narrative content for consistency with structured case data. The programmatic validation includes, for example, LLM inference operations to determine whether the narrative content is consistent with case data, as well as operations configured to cause the LLM inferences to be performed, such as automated generation of prompts to cause the LLM to validate the consistency.

In one embodiment, pattern checking agent(s) receive candidate statements from the master evaluator agent and retrieve the relevant interaction records from the case data. The pattern checking agent normalizes both the candidate statement content and the interaction record data into formats suitable for comparison. The pattern checking agent performs a semantic comparison between the normalized candidate statement and the corresponding interaction records by converting both into vector embeddings and computing similarity scores using an embedding-based similarity function, such as cosine similarity or dot-product distance. This semantic comparison enables the pattern checking agent to detect factual or contextual alignment between the statement text and the underlying case data even when phrasing, syntax, or linguistic structure differ. The resulting similarity score is evaluated against a configurable threshold to determine whether the statement is semantically consistent with the interaction records. In one embodiment, the pattern checking agents may also perform deterministic matching operations on the candidate statements and interaction records, such as string comparisons, numerical equality checks, and range validations. Based on these operations, each candidate statement is classified as either consistent or inconsistent with the case data. The correctness classification is returned to the master evaluator agent for aggregation and correction.

By performing embedding-based comparisons between candidate statements and structured source data, the system accurately identifies factual correspondence even across linguistic variation, thereby achieving higher precision with significantly lower computational resource consumption. The classification outcome, expressed as “consistent” or “inconsistent,” provides a binary signal that drives later correction and narrative refinement.

In one embodiment, narrative generation method 200 executes a programmatic validation of individual candidate statements against the interaction records to classify the individual candidate statements as consistent with or inconsistent with the interaction records as follows. The pattern checking agent receives candidate statements assigned by the master evaluator agent. The pattern checking agent retrieves the relevant interaction records from the case data. The pattern checking agent normalizes both the candidate statement content and record data into comparable formats. The pattern checking agent executes matching operations. The pattern checking agent determines whether each candidate statement is factually consistent with the data. The pattern checking agent produces a correctness classification (“consistent” or “inconsistent”) for each candidate statement. The pattern checking agent returns the classification to the master evaluator agent.

In one embodiment, the steps of block 225 are performed by pattern checking agent(s) 130. At the conclusion of block 225, narrative generation method 200 has transformed candidate statements into correctness classifications by comparing the statements with underlying interaction records, thus ensuring that all generalizing statements are explicitly validated against the structured case data. Processing continues to block 230.

At block 230, method 200 combines the validated statements from the one or more pattern checking agents into a final event narrative based on the corrected statements. The final event narrative exhibits improved factual reliability relative to the event narrative draft narrative generation method combines the evaluation results from the one or more pattern checking agents. In one embodiment, the master evaluator agent combines the draft narrative with the validated statements to produce a final event narrative that contains corrected and verified text. For example, the master evaluator agent replaces or modifies portions of the event narrative draft using the validated and corrected statements to produce a single, coherent final narrative.

The master evaluator agent programmatically merges validated statements into the narrative draft through automated text-alignment and substitution operations that maintain semantic continuity and factual consistency within the final event narrative. Individual validated statements are aligned with corresponding context spans in the draft segment, and the draft segment is updated with or replaced by the validated statement. The alignment may be determined based on similarity between embedded spans of text in the draft segment and embedded validated statements. For example, a threshold for alignment may be met when similarity between a validated statement and a draft segment exceeds a configurable cosine-similarity value. The assists in preserving narrative flow and factual grounding in the final event narrative. Thus, the combination of the validated statements and draft event narrative into the final event narrative involves contextual replacement or modification of the narrative draft using validated statements, guided by semantic alignment.

In one embodiment, the final event narrative retains original, unmodified draft content where validated statements confirm correctness and substitutes corrected content where inconsistencies are detected. Thus, the validated statements that are worked into the final event narrative are those for which the candidate statement was incorrect, and the pattern checking agent has detected the error and provided a valid, corrected statement. The semantic alignment ensures that these corrected statements are placed into the event narrative at the positions where factual inconsistencies occurred, without disrupting adjacent narrative context. This context-preserving synthesis produces an internally consistent narrative without regenerating the entire document from draft to final form, thereby reducing computation and preserving authorial structure.

In one embodiment, the narrative generation method 200 combines the validated statements from the one or more pattern checking agents into a final event narrative based on the corrected statements as follows. The master evaluator agent receives the validated and corrected statements from the pattern checking agents, each corrected statement mapped to a unique segment of the narrative draft. Where there is a corrected statement, narrative generation method 200 replaces the corresponding segment mapped to the corrected statement with the corrected statement. Where there is no corrected statement, the master evaluator agent preserves the original text while re-evaluating surrounding context to maintain coherence. The master evaluator agent thus incorporates updated and preserved segments into a unified narrative structure. In one embodiment, the master evaluator agent may execute final deterministic checks on numeric, temporal, and entity references to ensure alignment with structured case data. The master evaluator agent outputs the resulting text as the final event narrative and stored as part of the case record.

In one embodiment, the steps of block 230 are performed by narrative module 140 of master evaluator agent 125. At the conclusion of block 230, narrative generation method 200 has transformed the event narrative draft and the validated statements into a unified, verified narrative by replacing draft text segments with corrected, data-consistent statements. Through selective integration guided by semantic alignment, the narrative generation system achieves a high-fidelity, verified event narrative suitable for automated case reporting. Processing continues to end block 235, where method 200 completes.

### Example Additional Features of Narrative Generation Method

In one embodiment, the narrative generation method 200 further combines the final event narrative with a plurality of other final event narratives into a case report. The event narratives are combined using a case report generation agent. The case report provides a machine-generated explanation of system alerts. In one embodiment, the narrative generation method further includes in the case report additional non-alerted interactions associated with the entity.

In one embodiment, the interactions monitored by the interaction monitoring system are one of financial transactions, computer security events, clinical events, sensor events, utility grid events, call detail records, or package scan or location events. In one embodiment, the interactions monitored by the interaction monitoring system are financial transactions. In one embodiment, the interactions monitored by the interaction monitoring system are computer security events.

In one embodiment, the narrative generation method 200 further includes steps for including analytics of the case data in the event narrative. The method 200 generates analytics of the case data. The narrative generation method 200 generates the analytics using a deterministic auxiliary tool. The analytics may be statistical summaries of the case data, such as counts, sums, minimum/maximum amounts, date ranges for interactions. The narrative generation method 200 also excludes the analytics output from the deterministic auxiliary tool from inclusion in the candidate statements. The narrative generation method 200 excludes the analytics output using the generation agent. And, the narrative generation method 200 verifies inclusion of the analytics in the final event narrative. The narrative generation method 200 verifies the inclusion of the analytics using the master generation agent.

In one embodiment, the distributing the candidate statements to pattern checking agents (as discussed above at block 220) further includes transmitting the one or more candidate statements to the plurality of pattern checking agents operating in parallel. The narrative generation method 200 transmits the candidate statements using the master evaluator agent.

In one embodiment, the majority voting procedure (as discussed above at block 230) further includes executing additional evaluations of candidate statements classified as incorrect and applying majority voting to the additional evaluations.

In one embodiment, in the narrative generation method 200, an LLM used by one of the pattern detector agent, master evaluator agent, and pattern checking agents has model parameters that are distinct from a LLM used by the generation agent. For example, the model parameters include a temperature setting that is higher than that used by the generation agent.

### —Discussion of Narrative Generation System—

The narrative generation system introduces a novel framework for generating Transaction Monitoring case reports. In order to cover relevant alert (henceforth called event) details, stand-alone event narratives are generated, which are then collated into one coherent case report. As shown in FIG. 3, the event narrative generation 320 is split into a generation agent 325 and a multi-step evaluation agent (evaluation module 375). The multi-step evaluation agent (evaluation module 375) adopts a chain-of-verification strategy, with adjustments for detecting evaluation-worthy statements in event narratives and additional majority-based evaluation inspired by self-consistency, thereby mitigating the hallucination problem of LLMs and improving the reliability of the generated report.

The narrative generation system is described in the context of financial transaction monitoring as an illustrative example application. However, the techniques disclosed herein are not limited to financial systems and may also be applied to other alerting environments, including but not limited to computer security monitoring, network intrusion detection, healthcare monitoring, and industrial process supervision.

Financial Institutions (FIs) are mandated to comply with Anti-Money Laundering (AML) regulations enacted by various controlling entities across jurisdictions. To monitor for risk factors and red flags highlighted by regulators, FIs typically have automated Transaction Monitoring (TM) systems in place that implement deterministic rules (here called Scenarios). Scenarios produce alerts/events whenever transactional behavior consistent with one or more risk factors is detected, which may suggest suspicious activity and possible money laundering activities.

Because individual events are likely to be false positives, FIs typically seek to increase the signal by collecting together multiple events that refer to the same focal entity. These collections are called cases, and they are manually reviewed and investigated by compliance organizations within FIs.

If a Case does signal illicit activity, FIs are required to file a Suspicious Activity Report (SAR) with the competent regulator. If not, a disposition report still needs to be crafted, addressing the details of the case. Significant time is usually being spent in gathering and collating the relevant facts of the case, as well as writing the report itself. As such, devising a system that can automate large parts of the investigation and report crafting processes is of great value to FIs.

Previous attempts at automating case reporting have been unsatisfactory because they often rely on direct extraction of structured data or simple template filling without ensuring factual consistency across narrative text. Such systems typically produce outputs that either duplicate transaction logs or insert unverified summaries into report templates, which results in incomplete, inconsistent, or misleading narratives. Other approaches use large language models in isolation to generate full narratives, but these outputs suffer from hallucinations, omission of critical details, and variability due to stochastic generation. Consequently, prior solutions have failed to deliver reliable, coherent case narratives that can be trusted for compliance or investigative purposes. In one embodiment, the narrative generation systems and methods described herein improve the technology of automated narrative generation over the prior systems by delivering reliable, coherent, and highly accurate narratives that can be trusted for compliance or investigative purposes.

FIG. 3 illustrates an example narrative generation system 300 that is associated with use of AI agents to automate case narrative generation for monitoring systems. The narrative generation system 300 provides an end-to-end solution to automatically generate case reports 305 starting from the case data 310. The narrative generation system uses an architecture that includes multiple LLM components (agents): data preprocessing 315; event narrative generation 320, including generation agent 325, pattern detector agent 330, master evaluator agent 335, and pattern checking agent 340; and case report generation 345.
1. Case Data 310—Case data 310 includes the interactions (e.g., transactions), alert highlights, and entity information that are associated with the events which make up the case. The interactions are provided as structured records representing discrete activities or events, such as transactions or communications, that are subject to monitoring. The alert highlights are scenario-dependent attributes, automatically generated for each event. For example, the alert highlights may be provided as data fields or markers generated by a monitoring system that indicate specific aspects of an interaction which triggered an alert condition. Entity information is information about the focal entity, which may be provided as structured attributes describing parties or objects associated with an interaction, including identifiers (numeric or textual values that uniquely identify an entity, such as account numbers, customer IDs, social security numbers, IP addresses, or device identifiers), classifications (labels that categorize an entity according to role or attributes, such as customer type, risk rating, geographic region, organizational role, or industry code), or relationships (labels that link or associate entities and describe how they are connected, such as account ownership, shared address, transaction counterparties, organizational affiliation, or communication patterns).
2. Data Preprocessing 315—The case data 300 might be preprocessed by data pre-processing 315 to make it understandable for an LLM. Data pre-processing 315 can include aligning date formats, adding alert highlight descriptions, or renaming columns. In one embodiment, alert highlight descriptions refers to descriptive metadata that define the semantics of alert highlights, including the name, purpose, and contextual meaning of each attribute produced by the monitoring system to characterize a detected event. For example, if the monitoring system raises an alert for a High-Risk Geography Transaction, an alert highlight might be: “alert_highlight_name: total_amount_HRG_transactions,” and the alert highlight description might be “alert_highlight_description: ‘The aggregate amount of all transactions involving high-risk geography jurisdictions.’” The alert highlight descriptions may be injected as contextual metadata into LLM input prompts for event narrative generation 320 below. This allows the LLMs for the event narrative generation 320 to more correctly reference and explain the values of the alert highlights in natural-language form with reduced misinterpretation of the regulatory or analytical significance of the values.
3. Event Narrative Generation 320—Event narrative generation 320 is submodule that generates a narrative 350 for a single event of an arbitrary scenario. The event narrative generation 320 summarizes the event data, namely alerted transactions, alert highlights and entity data. The event narrative generation 320 is itself structured into multiple agents—generation agent 325, pattern detector agent 330, master evaluator agent 335, and pattern checking agent 340—as shown in expanded view 355 of event narrative generation 320. In one embodiment, event narrative generation 330 transforms structured case data 310 into validated narrative text (final event narrative 350) through coordinated operation of these agents. The agents access or operate one or more LLMs. Initially for a given event, event narrative generation 330 supplies case data that has been normalized to a consistent schema by data pre-processing 315 to a generation agent 325.
3-1. Generation Agent 325—Using the mentioned input data and supported by one or more tools 360 to aggregate the transaction data, the generation agent 325 produces the base of the event narrative 350: event narrative draft 365. In one embodiment, generation agent 325 invokes an LLM to perform contextual text generation using stored prompt templates that indicate what elements the narrative is to include and what parameter configurations to use to produce event narrative draft 365. In addition to instructions about what elements a narrative is supposed to contain, generation agent 325 receives multiple example event narratives 370 to ensure a consistent format and content. The instructions may involve the basic structure of the event narrative draft 365 (example shown below), and explain what information are of interest (for an example, see the discussion of “Preamble” below). An example event narrative structure follows:

### Event Narrative Structure

<Short summary paragraph of the alerted transaction data mentioning the scenario name, timeframe and amount.>
<Paragraph describing the main entity of the event.>

The alerted transactions are the following:
<Detailed summary of the alerted transactions broken down by transaction type including their count and sum as well as interesting patterns.
The alert highlights show <mention the value for every alert highlights that is mentioned to be important in the scenario description.>
   This example event narrative structure may be included in a prompt template for generating the event narrative draft 365.

In one embodiment, tool(s) 360 perform deterministic data analyses on the interaction records for use by the narrative generation agents. For example, tools 360 may provide the basic statistical summary of the transaction data (e.g. counts, sums, minimum/maximum amount, minimum/maximum date for transaction types) by executing simple arithmetic operations (for an example, see the discussion of “Tool Use” below). More generally, the tool(s) 360 are deterministic auxiliary tools which are configured to perform structured, rule-based analyses of case data—including numerical summarization, statistical aggregation, entity resolution, relationship mapping, temporal or geographic standardization, anomaly detection, or other programmatic validations—to provide reliable outputs that support, compliment, and/or constrain large language model results.

A variety of tools 360 may be used, depending on the context of the narrative generation. In addition to the aggregation tool used for providing statistical summarization of transactions described in the example context of transaction monitoring, the following tools may also be employed, as appropriate by context and the expected output narrative: an outlier detection tool configured to flag unusually large or small amounts compared to history; a trend analysis tool configured to compute growth over time or averages such as rolling averages; a clustering tool configured to group interactions by geography, counterparty, or time window;
3-2. Pattern Detector Agent 330—As the first part of an event narrative Evaluation Module 375, the Pattern Detector Agent 330 extracts statements from the narrative draft 365 that should be evaluated for correctness. Thus, the statements in the event narrative that qualify for evaluation for correctness are those statements that match a particular pattern: the pattern of inferring information from the input data. That means, the statement should not simply be citing the input data, but make some generalizing, summarizing, or other inferential statement instead. Also, the narrative generation system 300 does not consider mere citations of the tool 360 results from the Generation Agent 325 as satisfying the patterns because: 1) the tool 360 results are correct by design; and 2) there is a separate programmatic evaluation logic for mentions of the tool 360 results. More formally, therefore, a statement qualified for evaluation is a machine-identified text segment within an event narrative draft that expresses an inferred or aggregated conclusion derived from underlying case data, excluding direct citations of deterministic tool outputs. The statement may be represented as a discrete data object suitable for automated factual evaluation.

In one embodiment, pattern detector agent 330 is trained to extract statements to be evaluated for correctness using one or more example patterns 390. As discussed above, to qualify for evaluation a statement should be aggregating, generalizing, or otherwise inferring information from the input data. Thus, to extract a statement by pattern detector agent 330, the pattern detector agent 330 applies a large language model (LLM) to the event narrative draft 365 to perform a linguistic parsing and semantic pattern recognition that distinguishes generalizing or summarizing text spans from direct data citations. Pattern detector agent 330 identifies boundary tokens that mark the start and end of each candidate statement, reconstructs necessary contextual phrases from surrounding text to preserve semantic completeness, and outputs a structured representation that includes the original text fragment, its contextual clarification, and metadata indicating its source location for downstream evaluation. Thus, to allow an evaluation of the extracted statement in isolation, the respective text that matches the pattern of being generalizing or summarizing text is extracted from the narrative draft and then enriched with context to create a self-contained statement.

Example patterns 390 serve as training and guidance data for the pattern detector agent 330. They define the linguistic and semantic characteristics that distinguish evaluable statements—such as generalizations, aggregations, or inferred relationships—from simple factual citations. During runtime inference, the pattern detector agent 330 compares segments of narrative text against these example patterns to learn or recognize recurring syntactic and semantic structures that indicate a candidate statement. In operation, example patterns 390 enable the agent to consistently extract evaluable statements by providing representative templates of phrasing, grammatical structure, and contextual cues that signify summarization or inference within the event narrative draft.

In one embodiment, example patterns 390 include examples representing aggregation, generalization, correlation, anomaly, distribution, comparative, and conditional forms of reasoning, each expressed as linguistic exemplars that guide the pattern detector agent 330 in distinguishing evaluable statements from direct data citations during event narrative analysis. Aggregation patterns indicate that the narrative summarizes multiple records into a single quantitative or categorical conclusion. E.g., “Most of the wire transfers occurred in the first quarter of the year.” Generalization patterns express an inferred trend or behavioral regularity rather than citing a single factual record. E.g., “The customer regularly receives deposits from high-risk jurisdictions.” Correlation or relationship patterns link two or more variables in a way that implies association or causation. E.g., “Branch visits coincide with same-day large deposits.” Anomaly or deviation patterns identify behavior that deviates from expected or typical activity. E.g., “Transactions occurred outside normal business hours.” Distribution or frequency patterns characterize how events are distributed over time, geography, or other categorical dimensions. E.g., “High-value transactions were clustered near quarter-end.” Comparative patterns compare groups or time periods within the case data. E.g., “Deposits from foreign entities exceed domestic deposits.” And, conditional or exception patterns describe logical conditions or exceptions inferred from the data. E.g., “If a transaction exceeded $9,000, it was always followed by a same-day withdrawal.” Example patterns 390 may include a variety of such linguistic exemplars of each type (or of other types), categorized by type.
3-3. Master Evaluator Agent 335—In one embodiment, each of the statements 380 that matched a pattern, as detected by pattern detector agent 330 in the previous step will be evaluated for correctness. The Master Evaluator Agent 335 distributes the statements 380 such that each single pattern 385 is evaluated in isolation by the Pattern Checking Agent 340. Afterwards, once the results are gathered, the event narrative draft 365 is reviewed, incorporating the feedback from the pattern evaluations, yielding the final version of the event narrative—final event narrative 350—as output.

The master evaluator agent 335 receives extracted statements 380 from the pattern detector agent 330 and prepares single statements 385 for factual verification. In one embodiment, each of statements 380 is indexed, serialized into a standardized data format, and associated with relevant interaction records and alert highlights. The master evaluator agent 335 thus forms an evaluation package for each single statement 385 of the extracted statements 380. The master evaluator agent 335 assigns one packaged single statement 385 to a pattern checking agent 340. The master evaluator agent 335 may dispatch the evaluation packages asynchronously or in parallel, ensuring independent processing of the single statements 385. Upon completion of the evaluations, the master evaluator agent 335 collects structured results from the pattern checking agents 340, including correctness classifications, reasoning data, and any proposed corrections. The aggregated results are used in subsequent majority voting or synthesis operations to produce a corrected and verified event narrative.
3-4. Pattern Checking Agent 340—In one embodiment, the pattern checking agent 340 takes a single statement 385 as input and evaluates its correctness. In particular, the pattern checking agent 340 receives a single pattern 385 as input and performs an automated factual verification process to determine whether the pattern is supported by the underlying case data. The generation agent 325 has access to the input data used by the generation agent 325 (from the package of interaction records, alert highlights, and entity information relevant to the statement being evaluated). The generation agent 325 evaluates the single statement 385 as either ‘Correct’ if it is supported by the data or ‘Incorrect’ otherwise.

In one embodiment, the pattern checking agent 340 parses the text of the single statement 385 to identify the specific data attributes, entities, and relationships reference by the single statement 385.

Pattern checking agent 340 executes a programmatic validation between the extracted attributes in the pattern and the corresponding values in the case data. This comparison includes validating that numeric quantities, date ranges, transaction types, and entity identifiers appearing in the pattern align with those recorded in the input data. And, for textual elements of the single statement 385 pattern checking agent 340 employs an embedded large language model (LLM) to evaluate semantic consistency between the single statement 385 and the identified data attributes, entities, and relationships in the packaged interaction records, alert highlights, and entity information. The pattern checking agent 340 then classifies the statement as either consistent or inconsistent with the interaction records. Each evaluation produces a structured output including the classification result and reasoning metadata associated with the statement. These results are then transmitted to the master evaluator agent 335 for aggregation.

Each pattern checking agent 340 operates in an isolated execution environment, receiving (in addition to prior training) only the data provided in the evaluation package to evaluate a single statement 385 assigned to the checking agent 340. This prevents unintended contextual interference and ensures that each correctness determination is made solely on the factual bases relevant to the individual statement.

The pattern checking agent 340 determines correctness (i.e., consistency with the input data) by applying two threshold-based criteria. In one embodiment, deterministic fields, such as counts, totals, date ranges, and entity identifiers, are to match corresponding values in the interaction records exactly or within predefined numeric or temporal tolerances.

In case of an evaluation with the result ‘Incorrect’, additional evaluations of the same single statement 385 are conducted, up to a configurable number of evaluations. Thus, one single statement 385 may be checked independently several times by a pattern checking agent 340. Pattern checking agent 340 then combines multiple (e.g., all) evaluations of a single pattern 385 into the final evaluation result 350 by applying a majority vote. In one embodiment, the configurable number of evaluations is odd, to prevent draws in voting. In one embodiment, the configurable number of additional evaluations is 9 or fewer.

When the pattern checking agent 340 produces evaluation results indicating that one or more statements are invalid—inconsistent with the interaction records—pattern checking agent initiates a correction workflow using an embedded LLM. In the correction workflow, pattern checking agent 340 performs a text re-generation process for one or more (or each) invalid statement that controls the portions of text that are to be updated. Pattern checking agent 340 first identifies the specific data attributes or linguistic segments responsible for the inconsistency and isolates them within the statement text. The pattern checking agent 340 then assembles and transmits a structured correction request to the LLM. The request includes the original statement text, the identified inconsistency, and the verified data values from the underlying interaction records, along with guidance instructions that constrain the LLM to preserve contextual meaning while replacing incorrect information. The LLM processes this request by generating a corrected version of the statement that aligns with the validated data attributes while preserving the grammatical and contextual integrity of the event narrative. The pattern checking agent 340 re-checks the proposed correction to ensure correctness.

In one embodiment, the single statement 385 may be checked independently the configurable number times, regardless of whether the single statement 385 is correct or not. Multiple (e.g., all) evaluations of a single pattern 385 are then combined into the final evaluation result 350 by applying a majority vote.

Once validated, the Master Evaluator Agent 335 replaces the invalid statements in the event narrative draft 365 with the corrected counterparts to the invalid statements and merges the corrected statements with the set of previously validated statements. The resulting collection of verified and corrected statements is then aggregated in sequence to produce the final event narrative 350, which represents a factually consistent, machine-verified account of the event suitable for downstream case reporting.
4. Case Report Generation Agent 345—Taking as input one or more (e.g., all) the event narratives 395 generated for the events within the case, the Case Report Generation Agent 345 creates the final case report 305. As additional input, one or more (or all) additional transactions for the lookback period are provided and included in the report 305. These additional transactions are transactions which were not alerted for any event in the case. Examples of case reports 397 are also supplied in this step to ensure a consistent structure and output format.

The case report generation agent 345 receives validated, final event narratives, case-level metadata, and additional non-alerted interaction records associated with the focal entity. The case report generation agent 345 parses each narrative to extract event type, timeframe, entities, and quantitative summaries, and then orders the narratives by temporal or scenario-based criteria. The case report generation agent 345 constructs a prompt to cause generation of the case report 395. In one embodiment, the prompt includes the validated event narratives, case metadata, and non-alerted interaction records for the applicable lookback period. It also specifies schema-level constraints identifying numeric and temporal values that must appear verbatim from the verified data, along with formatting directives defining section order, paragraph structure, and output style. The prompt may further incorporate one or more example case reports 397 that demonstrate target formatting, structural layout, and linguistic style for reference by the LLM. These inputs enable the LLM to generate a coherent and data-consistent case report that merges all verified event narratives into a single structured output.

The case report generation agent 345 executes the LLM on the prompt to merge the ordered narratives into a unified text of a case report. In one embodiment, the LLM is configured (e.g., at runtime by the prompt) for multi-document synthesis. The LLM generates connective sentences and resolves redundant or conflicting information. The case report generation agent 345 subsequently executes deterministic validation checks to confirm that all quantitative values, entity identifiers, and date ranges remain consistent with the underlying case data 310, and formats the verified output according to a structured report schema for downstream compliance or regulatory use. The final output is a machine-verified, human-readable case report that provides an aggregated, factually consistent summary of the complete set of related events within the monitored case.
5. Multiple LLMs—In one embodiment, the narrative generation system 300 employs discrete LLMs for the different steps. Specifically, for the event narrative evaluation, narrative generation system 300 employs a larger LLM than for the event generation. This allows narrative generation system 300 to mitigate mistakes induced by model-specific weaknesses and to balance performance and cost-effectiveness for each step. Narrative generation system 300 also adapt the model hyperparameters for the different steps, so that narrative generation system 300 may use higher temperature values for the additional evaluations to allow diverse responses.

In one embodiment, each agent within the narrative generation system is implemented with its own discrete LLM, optimized for the specific computational and linguistic tasks assigned to that agent. This modular configuration of discrete LLMs allows the system to tailor model parameters, context handling, and computational resource allocation for each phase of processing, improving efficiency, factual reliability, and scalability relative to single-model architectures.

In various embodiments, the LLMs accessed by the agents may be hosted locally, remotely, or in a distributed configuration, provided that each agent executes or communicates with an LLM instance configured for its assigned linguistic or computational function. Local hosting of an LLM deploys the model weights and inference engine within a shared computing environment or infrastructure with the corresponding agent that uses the LLM. E.g., the agent and model run in separate containers or processes on a common host, and the agent invokes the LLM through a local inference API or runtime. In this way, the agent may execute or interface with the model directly without reliance on external network resources. In one embodiment, the LLM is embedded within the agent such that the code base of the agent includes the model weights and inference logic.

In some embodiments, one or more agents access large language models that are hosted remotely or in a distributed computing environment. In such configurations, the agents communicate with the models through secure API calls or service endpoints exposed by a cloud infrastructure. This arrangement enables dynamic allocation of computational resources, elastic scaling of model instances, and shared access to high-capacity foundation models that exceed the memory or processing limits of local systems. In further embodiments, the narrative generation system operates in a hybrid configuration in which lightweight local models are used for event narrative generation and verification tasks, while higher-capacity remote models are invoked selectively for correction, synthesis, or aggregation functions. This hybrid approach allows the system to optimize latency, cost, and accuracy by matching model capability to task complexity, while maintaining reliable performance across variable computing environments.

### High-Level Discussion of Example Features

The narrative generation system introduces a novel multi-agent LLM setup specifically tailored to generate interaction monitoring case reports, utilizing a bottom-up approach where relevant parts are detected and evaluated for correctness and the individual event narratives are collated into the final report. The narrative generation system introduces the following features which were not previously available:
1. A bottom-up approach of generating case reports where event narratives are generated for each event in a case. These event narratives then serve as building blocks for the case report.
2. The use of transaction aggregation tools during the event narrative and case report generation to support handling numeric values.
3. Programmatic Evaluation of the event narrative draft, checking that the aggregated, numeric values are mentioned, as expected.
4. Extraction of parts from the event narrative for additional evaluation and enrichment of the extracted parts with context so that they can be evaluated in isolation from each other.
5. Evaluation with self-consistency-inspired majority voting: To reach more consistent evaluation results the narrative generation system evaluates each pattern to be classified as incorrect multiple times and unify the corrections proposed by the evaluators.

In one embodiment, in the narrative generation system 300, evaluation techniques such as the chain-of-verification approach are modified by extraction of parts from the event narrative (Point 4 above) and evaluation with self-consistency (Point 5 above). A detailed explanation on how the approach applied in the narrative generation system differs from the chain-of-verification approach follows. “Chain-of-verification” as used herein refers to an approach where an LLM first generates a baseline response (such as the event narrative draft 345) that may contain inaccuracies, and then it generates and executes a set of verification questions (such as is implemented by pattern detector agent 330, master evaluator agent 335, and pattern checking agent 340) to verify the initial response, and finally generates the improved response (such as final event narrative 350) based on the verification questions and their corresponding answers.

The generation procedure of the verification questions set is modified as described by Point 4, extraction of parts from the event narrative for additional evaluation and enrichment. This means that question generation is guided to detect the presence of meaningful patterns in statements rather than letting the LLM freely decide which questions to ask. Instead of generating questions that are independent of the original response, the narrative generation system evaluates individual (e.g., each) pattern while maintaining the exact quote in the narrative together with the clarification of the quote in the given context. This method allows the narrative generation system to retain ties to the original response and generate suggested corrections on top of the evaluation, while still making it possible to isolate the evaluation of each pattern.

The final response generation procedure is modified as described by Points 4 & 5. This means that, in case the pattern is evaluated to be wrong, the narrative generation system introduces the majority voting mechanism. This further increases the accuracy of the generated content and further mitigates the hallucination issue. The reasoning process of the final response generation is designed to be more explicit in this approach, increasing accuracy and explainability. The master evaluator agent aggregates evaluation results and suggested corrections (due to Point 4) from the majority voting process to come up with the final response. By contrast, in earlier approaches, the burden of (1) figuring out how the verification questions relate to the original response, (2) deciding what to trust between the original response and the verification answer, and (3) coming up with corrections are all left to the LLM in the final response generation stage.

The narrative generation system exhibits several advantageous improvements over existing solutions:
1. Inherent reliability by modularity: Compared to existing solutions, the narrative generation system framework improves the reliability of the case report by building the case report bottom-up from the event narratives and incorporating extensive validation and evaluation steps on the level of the event narrative. Generating the case report then mainly becomes a task of summarizing the individual event narratives and collating them into a coherent report.
2. Precise and risk-adjusted evaluation: By extracting only those parts from the narrative draft that include aggregating and generalizing statements, the narrative generation system can focus evaluation efforts on those parts that are prone to mistakes and hallucinations.
3. Use Case Agnostic: By using generic prompt templates that allow handling cases with different numbers of events as well as allowing events to be of arbitrary scenario types, the narrative generation system can handle a wide variety of interaction monitoring cases.
4. Compute cost and performance balancing: By employing discrete LLMs that are dedicated to the particular tasks of the corresponding agent, the narrative generation system: (a) uses models that are relatively stronger for the particular evaluation being performed, (b) mitigates model-specific mistakes, and (c) employs more cost-effective models (e.g., more lightweight models that consume fewer compute processing cycles and/or less memory) for the narrative generation. Additionally, different generation parameter configurations for the model temperature allow balancing of narrative consistency and diverse responses for multiple evaluations of the same statement.
5. Detailed insights by retaining event narratives: An additional advantage of the bottom-up approach taken by the narrative generation system is that the event narratives are created as a byproduct of the overall creation of a case report, so that the narrative generation system can also supply narratives on the event-level, not just on the case level.
6. The narrative generation system can use general purpose LLMs: The narrative generation system does not require any application-specific fine-tuning or retrieval augmented generation (RAG). In one embodiment, the narrative generation system performs satisfactorily with the out-of-the-box open-source LLMs such as Cohere command-r-plus and Meta llama 3.1 models.

This approach by the narrative generation system improves the reliability of the case report and is capable of generating a coherent final report that can greatly facilitate the investigation process.

### Example Operations and Prompts in Narrative Generation System

A detailed discussion of one example embodiment of a narrative generation system follows. The discussion illustrates data and prompts used in operation of various agents and other components of the narrative generation system.
1. Input Data—To generate a single case report, the initial input data (e.g., case data 310) includes:
   entities table containing information (name, address, data of birth, . . . ) for the involved entities (e.g., all entities that are involved) (customers, accounts, external entities, . . . )
   alert attributes for the alerts (e.g., each alert)—scenario-dependent attributes/highlights that are generated as part of the alert (attribute name, description and value)
   alerted transactions for the alerts (e.g., each alert)
   additional non-alerted transactions of the focal entity
2. Preamble—A preamble is prepended to prompts when generating narratives (e.g., by generation agent 325, master evaluator agent 335, and case report generation agent 345), detecting patterns (e.g., by pattern detector agent 330) and reviewing evaluations (e.g., by pattern checking agent 340 and master evaluator agent 335). The preamble provides context for the type of interaction, alert, and report being generated. For example, in the context of financial transaction monitoring, the preamble provides general background of a SAR (Suspicious Activity Report) and a brief description of the given scenario. An example of such a preamble follows in Table 1:

TABLE 1
---------- Input Prompt (excerpt) ----------
# Role
You are a helpful assistant to a financial investigator that investigates a particular matching the
following scenario description:
{{{{ {SCENARIO_DESCRIPTION} }}}}
Your role is to help the investigator create a SAR (Suspicious Activity Report). A SAR covers
answering questions regarding “Who, what, where, when, why” of a case. For that the following
‘SAR-ELEMENTS’ are of interest:
- a summary of the “red flags” and suspicious patterns of activity that initiated the SAR.
- any and all relevant facts about the parties (individuals and businesses) who facilitated the
suspicious activity or transactions. Include any unusual observations such as suspected shell
entities; financial activities which are not commensurate with the expected normal business flows
and types of transactions; unusual multiple party relationships; customer verbal statements;
unusual and/or complex series of transactions indicative of layering; lack of business justification
and documentation supporting the activity; etc.
- a specific description of the involved accounts and transactions, identifying if known, both the
origination and application of funds (usually identified in chronological order by date and amount);
- breaking out larger volumes of financial activity into categories of credits and debits, and by date
and amount;
- transactor and beneficiary information, providing as much detail as possible, including the name
and location of any involved domestic and/or international financial institution(s); names,
addresses, account numbers, and any other available identifiers of originator and beneficiary
transactor(s) and/or third parties or business entities on whose behalf the conductor was acting;
the date(s) of the transaction(s); and amount(s);
- an explanation of any observed relationships among the transactors (e.g., shared accounts,
addresses, employment, known or suspected business relationships and/or frequency of
transactions occurring amongst them; appearing together at the institution and/or counter);
- specific details on cash transactions that identify the branch(es) where the transaction(s)
occurred, the type of transaction(s), and how the transaction(s) occurred (e.g., night deposit, on-
line banking, ATM, etc.).
Your overall goal is to provide a narrative that answers these points as well as possible. However,
you should focus on the “Who, what, where, when” parts. Explaining why something is suspicious
is role of the investigator, not yours. You don't have to cover every single aspect mentioned in
these points, if you don't have enough information to answer some of these questions, leave them
away. Don't conclude something that you are not sure about and be careful to not hallucinate.
--------------------------------------------------

3. Generation Agent—A generation agent (such as generation agent 325) generates an event narrative given: (a) the input data mentioned above, (b) instructions, and (c) three examples (e.g., drawn from example event narratives 370). An excerpt from the LLM prompt containing the instructions and examples is shown in Table 2 below:

TABLE 2
----------Input Prompt (excerpt) ----------
# Task & Context
You should provide a narrative following your instructions for the following event.
1. Familiarize yourself with the event data.
This is the ‘alerted_transactions' table for the event including its summary:
{{{{ {ALERTED_TRANSACTIONS}.str }}}}
{{{{ {ALERTED_TRANSACTIONS_SUMMARY}.str }}}}
This is the ‘entities' table associated with the event. Beware, there can be additional entities that
are not listed in this table:
This is the ‘alert_highlights' table automatically generated for the event:
{{{{ {ALERT_HIGHLIGHTS}.str }}}}
You should build the narrative by:
1. You should summarize the alert data, the alert highlights, and the involved entities. If possible
also generate insights beyond summarizing the alert data to cover as many ‘SAR-ELEMENTS’ as
listed in your instructions.
Be careful when making generalizing statements such as something happening every month or
regularities in transaction amounts. It is valuable information but double-check that your statement
is really supported by the data. Do not simply assume that patterns from the examples are also
present in the event at hand. Provide the narrative only, without any introductory or concluding
phrases.
You are not restricted in the format of your narrative and can include any paragraphs that are
answering the questions listed above. But you should at least adhere to this minimal output format:
<Short summary paragraph of the alerted transaction data mentioning the scenario name,
timeframe and amount.>
<Paragraph describing the main entity of the event.>
The alerted transactions are the following:
<Detailed summary of the alerted transactions broken down by transaction type including their
count and sum as well as interesting patterns.
The alert highlights show <mention the value for every alert highlights that is mentioned to be
important in the scenario description.>
You can extend this format with additional elements useful to the SAR (as listed in the points
above) in any way you see fit. You should not output any tables.
Here are some example narratives for other events:
Example A:
“This Event with the scenario ‘Structuring - Avoidance of Reporting Thresholds' is alerted on the
basis of a branch referral and because of 6 alerted cash withdrawals spanning from March 2020
to August 2020 with a total amount of $54,000.
John Smith, born on February 1, 1986 and living in 12345 Main Street, Bangor, ME 04401, is a
chemical engineer and opened his personal checking account with Brick Bank on October 9, 2018.
Besides him, Jane Smith, born July 7, 1989, a veterinarian and living at the same address is also
a signer of that account.
The alerted transactions are the following:
Cash withdrawals: There are 6 cash withdrawals. All by John Smith from his personal checking
account. All are $9,000, just below the reporting threshold. Most of the withdrawals happened at
branch 1202, which is located in Bangor, ME 04401, the same city as the account's address. Two
withdrawals however occurred at branch 1238 in Indianapolis, IN 46107. This is notable as it is
located far away. All occurred between March 8, 2020 and August 12, 2020, once every month
and always between the 7th and 12th day of the month. The total transaction amount of the cash
withdrawals is $54,000. The alert highlights show 3 episodes of structuring attempts.”
Example B:
“This event with the scenario ‘High Risk Transactions: High Risk Geography’ is alerted on the basis
of an AML detection and because of 3 alerted incoming wire transfers from Country CY1, which is
flagged as a High-Risk Geography jurisdiction. They occurred between February 2020 and July
2020 with a total amount of $81,173.
John Brown, born on June 27, 1975 and living in 23456 Elm Street, Buffalo, NY 14211 is a
business owner, has a TIN of 123-45-6789 and is listed as signer for the “Brown Auto Mart”
business deposit account. The account was opened on October 12, 2019.
The alerted transactions are the following:
Wire transfers: There are 3 wire transfers. All are originating from Country CY1 by John Doe1.
They range between $22,865 and $30,075. They occurred on February 26, 2020; April 2, 2020;
and July 18, 2020. These high-risk geography transactions amount to $81,173. The alert highlights
indicate that this corresponds to 23% of the total amount of all transactions.”
Example C:
“This event with the scenario ‘High Risk Transactions: High Risk Geography’ is alerted on the basis
of an AML detection and because of 3 alerted incoming wire transfers from Country CY2, a High-
Risk Geography jurisdiction. They occurred between March 2020 and June 2020 with a total
amount of $118,792.
John Doe2, born March 26, 1964 and living in 34567 Pleasant Dr, Nice City, OH 12345 is a
business owner, has a TIN of 987-65-4321 and is listed as signer for the “A-Z Auto Sales” business
deposit account. The account was opened on January 24, 2020 and has 45678 High Street, Nice
City, OH 12345 as its listed address.
The alerted transactions are the following: Wire transfers: There are 3 wire transfers. All are
incoming from external entities from Country CY2. Two are by Sender X and one from Sender Y.
They range between $32,685 and $48,187. They occurred between March 18, 2020 and May 23,
2020, once every month. The high-risk geography transactions amount to $118,792. The alert
highlights indicate that this corresponds to 43% of the total amount of all transactions.”
Important Reminders:
- For every transaction type you are describing, you should always include the time period in which
the transactions occurred.
- Try to avoid terms like C1 and EE1 but use the associated names instead.
- You should only output total transaction amounts (the sum of multiple transactions) as well as
the number of a certain transaction type if you find that information in one of the input tables. Never
perform these counts and calculations yourself. If there is no information in the summary tables
about the number or sum of a certain transaction type, you should not report that information at
all
## Style Guide
Be professional and concise but include all the requested information. Avoid the word ‘suspicious'
- even if you find it in the data. Use ‘alerted’, ‘flagged’ or ‘triggered’ instead.
--------------------------------------------------

4. Pattern Detector Agent—A pattern detector agent (such as pattern detector agent 330) is configured to ensure that the relevant parts (e.g., statements) from the narrative draft are extracted for the downstream evaluation steps. An excerpt from an example LLM prompt used by the pattern detector agent shown in Table 3 below highlights the kind of statements that should be detected and extracted.

Note that in prompts (such as those given in tables 3, 4, and 5), and occasionally elsewhere herein, extracted statements that match patterns inferred by the LLM may be referred to simply as “patterns” for convenience. These patterns are natural language statements, such as sentences and or sentence fragments, aggregate, generalize, or otherwise infer collective data.

```
TABLE 3
---------- Input Prompt (excerpt) ----------
Detect all the patterns by proceeding in the following way:
- pattern_quote: Cite the respective part of the narrative that contains a pattern that the LLM
inferred. This should be an exact quote from the input narrative. Sometimes a sentence contains
more than one pattern, make sure to list every pattern individually and not group several of them.
Every generalization or data aggregation that is more than just citing some input data classifies
as a pattern. This includes generalizing statements about counterparties, transaction types, date
patterns, and transaction details such as the bank branch. Exceptions that should not be detected
are:
  - sums of transactions
  - percentages
  - counts of transactions
  - transaction amount ranges (min/max values) such as “ranging from $2,000 to
$7,000”
  - date ranges of transactions such as “between January 1 and July 31, 2020” as their
correctness was already checked.
- pattern_clarification: The quote itself might miss the relevant context to evaluate the pattern in a
stand-alone way. So if the claim made in the pattern is not clear from the quote, extend the quote
so that it becomes clear. Example: The pattern found in the middle of a sentence in the narrative
might be “always once every month” but as it is not clear what is claimed to happen once every
month you should add the relevant context and extend it in this step, for example: “The alerted
cash withdrawals happen always once every month.” Be careful that the focus remains on the
original pattern, so do not introduce additional elements such as the number of transactions here.
Your output should be formatted as a list of JSON objects with one JSON object for each pattern
like this:
[
  {
    “pattern_quote”: <quote pattern>,
    “pattern_clarification”: <clarify pattern>
    “affected_transactions”: <“single”, “multiple” or “none”>
  },
]
You should not output anything else, also no introductory or concluding sentences.
Following is an example response of detected patterns for another event:
[
  {
    “pattern_quote”: “living at the same address”,
      “pattern_clarification”: “John Smith and Jane Smith are living at the same
      address.”,
    “affected_transactions”:
“none”
  },
  {
    “pattern_quote”: “a flagged Official Bank Check (Official Bank Check) Credit from
John Smith into his personal checking account, followed by 6 flagged cash withdrawals”,
    “pattern_clarification”: “All flagged cash withdrawals into John Smith's personal
checking account occur after the flagged Official Bank Check.”,
    “affected_transactions”: “multiple”
  },
  {
    “pattern_quote”: “all $9,000 just below the reporting threshold.”,
    “pattern_clarification”: “All alerted cash withdrawals are $9,000 and below the
reporting threshold.”,
    “affected_transactions”: “multiple”
  },
  {
    “pattern_quote”: “once per month”,
    “pattern_clarification”: “The cash withdrawals occur exactly once every month.”,
    “affected_transactions”: “multiple”
  },
  {
    “pattern_quote”: “Transactions always happen on the same date as the cash
withdrawals.”,
    “pattern_clarification”: “The Official Bank Check credits always happen on the
same date as the cash withdrawals.”,
    “affected_transactions”: “multiple”
  },
  {
    “pattern_quote”: “First Official Bank Check credit is $60,000, subsequent ones
are always $9,000 lower (the same amount as is withdrawn).”,
    “pattern_clarification”: “The first Official Bank Check credit is $60,000, the
subsequent ones are always $9,000 lower which matches the amount that is withdrawn via the
cash withdrawals.”,
    “affected_transactions”: “multiple”
  },
  {
    “pattern_quote”: “The remaining cash withdrawals were made at branch 1234 in
Springfield, IL; at branch 2345 in Richmond, VA; and at branch 3456 in Columbus, OH.”,
    “pattern_clarification”: “Those cash withdrawals that were not made at branch
2231, were made at branch 1234 in Springfield, IL; at branch 2345 in Richmond, VA; and at branch
3456 in Columbus, OH.”,
    “affected_transactions”: “multiple”
  }
]
--------------------------------------------------
```

Note the following:
(A) Since each single statement (that matches the pattern that triggers evaluation) is to be evaluated in isolation, in addition to quoting the statement from the narrative that is to be evaluated, the narrative generation system enriches the quoted statement with context that makes it a stand-alone coherent statement.
(B) In one embodiment, only statements that aggregate or generalize the data are to be checked. That leaves out statements about single transactions. This was not reliably achieved by prompting techniques alone. Accordingly, the pattern detector agent outputs an additional key, affected_transactions, associated with each pattern-matched statement, so that the pattern detector agent and/or master evaluator agent can filter out statements that are respectively associated with a single transaction only.
5. Pattern Checking Agent—In one embodiment, a pattern checking agent (such as pattern checking agent 340) performs steps for evaluating a single extracted statement and a step that consolidates multiple individual evaluations of a single pattern into a final result. Table 4 below shows an example prompt design for one individual evaluation:

TABLE 4
---------- Input Prompt (excerpt) ----------
#Task & Context
You are a specialized reviewer for patterns in transaction data and a helpful assistant to the
financial investigator. A narrative was already created for the event and a list of statements and
patterns that should be checked for their correctness has been extracted from that narrative. Your
role is to take one specific statement and rigorously check its correctness using the event data
and correct it if necessary. Besides the pattern, you will be given the same tables that were used
for generating the statements. Use this data to check the patterns and for your reasoning. Not all
tables might be relevant for the given pattern.
1. Familiarize yourself with the event data.
This is the table for the alerted transactions of the event:
{{ ALERTED_TRANSACTIONS }}
}{ ALERTED_TRANSACTIONS_SUMMARY }}
This is the entities table associated with the event. Use it to connect originators and beneficiaries
to their names and additional information. Beware, there can be additional entities that are not
listed in this table:
{{ ENTITIES }}
This is the alert highlights table automatically generated for the event:
{{ ALERT_HIGHLIGHTS }}
2. Familiarize yourself with the statement that you should check:
{{ SINGLE_PATTERN }}
3. Check and correct the pattern by thinking step by step and proceed in the following way which
you can also use as the output format:
- Pattern: Cite the version of the pattern that you are evaluating.
- Reasoning: For that pattern, check all the relevant underlying data and check whether it supports
the claim made in the pattern. Be critical here, a pattern is only correct if it matches the data
exactly. However, you should not try to come up with a more refined pattern if the original one can
be considered correct. It's not your job to find a better or an even more accurate pattern. You
should only determine whether the pattern as stated is supported by the data. Ranges are always
inclusive.
- Correctness: Using the reasoning from the previous step, conclude whether the pattern is correct
or not. Make sure your conclusion matches the reasoning and the data. Here you should just say
‘Correct.’ or ‘Incorrect.’
- Correction (optional): Then, correct the pattern if necessary. Either say ‘Remove this part.’ and
then later remove the part containing mistakes from the narrative in case it was a pure hallucination
or say ‘Replace with:’ followed by an amended version of the false statement so that it is correct.
If you provide an amended version of the pattern, you should reflect whether that one is actually
correct. If uncertain, it is better to just remove the wrong pattern than replacing it with another
wrong one.
--------------------------------------------------

And, Table 5 below gives an example design for combining all evaluations for a single pattern into the final evaluation result:

TABLE 5
---------- Input Prompt (excerpt) ----------
# Task & Context
You are a helpful assistant to the financial investigator and responsible for creating the final
narrative. A narrative draft was already created for the event and a list of statements and patterns
were extracted and checked for their correctness. Your role is to resolve a conflict for one pattern
that was evaluated by multiple models who disagreed on its correctness. You will see all the
models' reasonings and conclusions. All models had access to the exact same data.
1. Familiarize yourself with the pattern and the model responses:
{{ SINGLE_PATTERN }}
{% for pattern in SINGLE_PATTERN_ADDITIONAL_EVALUATIONS %}
{{ pattern }}
{% endfor %}
2. Determine how to deal with this pattern in two steps (this is also the format of the output):
- Pattern: Cite the pattern again.
- Correctness: Return how many models say that the pattern is correct and how many say it is
incorrect. Based on the majority response of the models decide whether the pattern is correct or
incorrect.
- Correction: If you decide that the pattern is incorrect, think about how to deal with that. If the
individual models uniformly agree on a correction, apply that or try to find the minimal consensus.
For example if the specific number of transactions is disputed, you can remove the exact number
but leave the rest of the pattern. Otherwise, if the corrections are contradicting each other, remove
the pattern entirely. Important: You should only propose a correction in this step, if you deemed
the pattern incorrect in the previous step.
--------------------------------------------------

6. Master Evaluator Agent—In one embodiment, one part of the master evaluator agent implements a review step in which all pattern corrections and programmatic evaluation feedback is used to correct the narrative draft and produce the final version of the narrative (e.g., final event narrative 350). An example prompt design for this review and revision into a final event narrative is given in Table 6 below:

TABLE 6
---------- Input Prompt (excerpt) ----------
# Task & Context
You are a helpful assistant to the financial investigator and responsible for creating the final
narrative. A narrative draft was already created for the event and a list of statements and patterns
were extracted and checked for their correctness. Additionally, it was checked whether the outputs
of a summary tool were used in the narrative draft. You will receive a list of all the tool outputs that
are not occurring in the narrative. Your role is to take that list of checked statements as well as
the tool outputs and update the narrative draft by correcting the mistakes if any were found in the
patterns or if the tool outputs were not used correctly.
1. Familiarize yourself with the data:
These are the statements that were checked for correctness:
{% for single_pattern in ALL_PATTERNS %}{% ifpattern %}
{{ single_pattern }}
{% endif %}{% endfor %}
These are the tool outputs that are not in the narrative draft:
{{ PROGRAMMATIC_EVALUATION_RESULTS }}
This is the original narrative draft:
{{ EVENT_NARRATIVE_DRAFT }}
2. You should correct the original narrative in three aspects:
a. Depending on the correctness and the correction suggestions for the patterns, correct the wrong
statements in the original narrative. Make sure you only update or remove those parts of a
sentence that are concerned by the pattern.
b. If there are any missing or wrongly used tool_outputs, correct these in the narrative. Beware,
the tool outputs could either be missing from the narrative draft or a wrong number could have
been reported.
Briefly state, what changes will be applied to the narrative.
3. Return the narrative without the identified mistakes. You should only change the parts of the
narrative that are incorrect and leave the rest unchanged.
--------------------------------------------------

7. Tool Use—During the event narrative generation as well as the case report generation, the generation agent and master evaluator agent, respectively, use aggregation tools (such as tools 360) to provide counts, sums, minimum/maximum amount, minimum/maximum date for all transaction types. This avoids calculation mistakes by the LLM. In one embodiment, the event narrative generation system constrains the outputs of the tools to be included in the narratives. To ensure that these tool results are actually used, the generation agent performs a check on the narrative drafts as to whether these results (either by exact number or a rounded number) appear in the text. If not, the missing results are passed to the master evaluator agent and applied in the review step (see prompt design above and end-to-end example). An example tool result is given in Table 6 below:

TABLE 6
Summary:

| | | total_{—} | min_{—} | max_{—} | | |
|---|---|---|---|---|---|---|
| | number_of_{—} | transaction_{—} | transaction_{—} | transaction_{—} | first_{—} | last_{—} |
| | transactions | amount | amount | amount | transaction | transaction |
| Cash | 6.0 | 44700.0 | 2600.0 | 9900.0 | 2020 Feb. 13 | 2020 Jul. 6 |
| Withdrawal | | | | | | |
| Total | 6.0 | 44700.0 | 2600.0 | 9900.0 | 2020 Feb. 13 | 2020 Jul. 6 |

### —Effectiveness of Evaluation Module Demonstrated in Testing—

One example setup of the narrative generation system was tested for 40 event narratives coming from 26 different cases. The initial draft narratives contained 9 mistakes/hallucinations in total. 7 mistakes were correctly extracted, identified and corrected. 1 mistake was not extracted as a pattern. 1 mistake was phrased unclearly in the original narrative and was re-phrased to a correct pattern by the pattern detection agent, and subsequently corrected. In total, 95 patterns were extracted and evaluated. No correct patterns were falsely marked as being incorrect.

Additionally, in 4 narratives included in the test, there were statements that, while not being wrong in the narrative draft, were nevertheless imprecise. These statements too were improved by the subsequent evaluation process performed by evaluation module 375. For example:
Before: “The cash withdrawals occurred at various branches in different cities, including Houston, Austin, Portland, and Tacoma.”
After: “The withdrawals occurred at various branches in different cities, including Houston (with multiple branches), Austin, Portland, Tacoma, and Albany.”

After running through the evaluation module, there were two incorrect statements in total in the 40 event narratives. While summarizing those events to case reports, one of the statements was corrected because the other event narrative in the same case mentioned the fact correctly. The other statement was not mentioned in the final case report.

This leads to the following performance, as shown in Table 7:

TABLE 7

| Metric | Value |
|---|---|
| (Recall1) How many of the mistakes could it detect? | 0.78 (7/9) |
| (Recall2) How many of the detected mistakes could it correct? | 1 (7/7) |
| (Precision) How many of the patterns that were evaluated as | 1 (88/88) |
| being correct, were actually correct? | |
| (Accuracy1) Ratio of correct event narratives. | 0.95 (38/40) |
| (Accuracy2) Ratio of correct case reports. | 1 (26/26) |

These results demonstrate that the evaluation module is effective and that the pipeline of the narrative generation system produces case reports that are more factually correct than those generated without the aid of the narrative generation system. This demonstrates a substantial technical improvement over using the initial draft narratives: 78% of mistakes by the initial LLM were automatically eliminated.

### End-to-End Example

The following is an end-to-end example case that has two events:
Event 1: “High Risk Geography (HRG) Transactions”: Transactions that involve jurisdictions which are considered to be of high risk by the financial institution.
Event 2: “Structuring—Avoidance of Reporting Thresholds”: Jurisdictions have reporting thresholds for cash transactions. Multiple transactions that seem to be structured to avoid these thresholds might indicate suspicious behavior.

This example was modified so that the maximum amount of the wire transfers was not reported correctly in order to demonstrate the programmatic evaluation of the tool results.

TABLE 8
Input Data - Alerted Transactions for HRG are given in Table 8:

| From Entity | To Entity | Transaction | | | |
|---|---|---|---|---|---|
| (Originator) | (Beneficiary) | Type | Other | Amount | Date |
| EE1 | A1 | Wire transfer | Country of | 18256.0 | 2020 Mar. 19 |
| | | | origin: | | |
| | | | Country CY3 | | |
| EE1 | A1 | Wire transfer | Country of | 12678.0 | 2020 May 6 |
| | | | origin: | | |
| | | | Country CY3 | | |
| EE1 | A1 | Wire transfer | Country of | 20015.0 | 2020 May 28 |
| | | | origin: | | |
| | | | Country CY3 | | |
| EE1 | A1 | Wire transfer | Country of | 17364.0 | 2020 Jun. 23 |
| | | | origin: | | |
| | | | Country CY3 | | |

Alerted Transactions for Structuring are given in Table 9:

TABLE 9

| From Entity | To Entity | Transaction | | | |
|---|---|---|---|---|---|
| (Originator) | (Beneficiary) | Type | Other | Amount | Date |
| A1 | C1 | Cash | Branch 4567: | 8700.0 | 2020 Feb. 13 |
| | | Withdrawal | Cleveland, | | |
| | | | OH 44142 | | |
| A1 | C1 | Cash | Branch 5678: | 2600.0 | 2020 Feb. 14 |
| | | Withdrawal | Buffalo, NY | | |
| | | | 14203 | | |
| A1 | C1 | Cash | Branch 4567: | 8800.0 | 2020 Apr. 4 |
| | | Withdrawal | Cleveland, | | |
| | | | OH 44142 | | |
| A1 | C1 | Cash | Branch 6789: | 5500.0 | 2020 Apr. 5 |
| | | Withdrawal | Indianapolis, | | |
| | | | IN 46107 | | |
| A1 | C1 | Cash | Branch 4567: | 9900.0 | 2020 Jun. 13 |
| | | Withdrawal | Cleveland, | | |
| | | | OH 44142 | | |
| A1 | C1 | Cash | Branch 4567: | 9200.0 | 2020 Jul. 6 |
| | | Withdrawal | Cleveland, | | |
| | | | OH 44142 | | |

The entities are given in Table 10:

TABLE 10

| En- | | | | | | | | | | | | | |
|---|---|---|---|---|---|---|---|---|---|---|---|---|---|
| tity | Entity | | | | | | | | Occu- | | | Insti- | |
| ID | Type | Label | Name | ID | TIN | Address | Date | DOB | pation | Status | Source | tution | Signer |
| A1 | Account | Business | Big | 35323456 | 26- | 45678 | 2019 | NaN | NaN | Open | AML | Brick | John |
| | | Deposit | Auto | 29784 | 4458893 | Long Road, | Nov. 24 | | | | Detec- | Bank | Doe5 |
| | | Account | Sales | | | Highland, | | | | | tion | | |
| | | | | | | OH 44143 | | | | | | | |
| C1 | Customer | NaN | John | NaN | 858-46- | 23456 | NaN | 1984 | Busi- | NaN | NaN | NaN | NaN |
| | | | Doe5 | | 3352 | Pleasant | | May 22 | ness | | | | |
| | | | | | | Dr, Nice | | | Owner | | | | |
| | | | | | | City, OH | | | | | | | |
| | | | | | | 44141 | | | | | | | |
| LE1 | Legal | NaN | Big | NaN | 26- | 45678 | NaN | NaN | NaN | NaN | NaN | NaN | NaN |
| | Entity | | Auto | | 4458893 | Long Road, | | | | | | | |
| | | | Sales | | | Highland, | | | | | | | |
| | | | | | | OH 44143 | | | | | | | |
| EE1 | External | NaN | John | NaN | NaN | NaN | NaN | NaN | NaN | NaN | NaN | NaN | NaN |
| | Entity | | Doe7 | | | | | | | | | | |

Alert Highlights for HRG are given in Table 11:

TABLE 11

| Alert highlight | highlight_descripion | highlight_value |
|---|---|---|
| total_amount_VHRG_transactions | The aggregate amount of all Very | 0 |
| | HighRisk Geography transactions | |
| | involved in the event. | |
| total_num_VHRG_transactions | Total number of Very High Risk | 0 |
| | Geography transactions involved in the | |
| | event. | |
| total_amount_all_transactions | The aggregate amount of all | 233364.44 |
| | transactions involved in the event. | |
| HRG_perc | The percentage of total transaction | 0.293 |
| | amount which involves High Risk | |
| | Geography transactions | |
| total_num_HRG_transactions | Total number of High Risk Geography | 4 |
| | transactions involved in the event. | |
| total_amount_HRG_transactions | The aggregate amount of all High Risk | 68313 |
| | Geography transactions involved in the | |
| | event. | |
| total_amount_HRG_transactions_frequency_period | The aggregate amount of all High Risk | 68313 |
| | Geography transactions involved in the | |
| | event within the Frequency Period. | |

Alert Highlights for Structuring are given in table 12:

TABLE 12

| Alert highlight | highlight_descripion | highlight_value |
|---|---|---|
| number_of_attempts | Number of attempts of | 3 |
| | structuring activity. | |
| minimum_account_count | Minimum number of | 1 |
| | accounts associated with | |
| | the focal customer. | |

Additional (non-alerted) transactions are given in Table 13:

TABLE 13

| From Entity | To Entity | Transaction | | | |
|---|---|---|---|---|---|
| (Originator) | (Beneficiary) | Type | Other | Amount | Date |
| EE3 | A1 | Check Credit | Vehicle | 7219.45 | 2020 Jan. 30 |
| | | | Purchase no. | | |
| | | | 268980 | | |
| EE4 | A1 | Check Credit | Vehicle | 6437.41 | 2020 Mar. 3 |
| | | | Purchase no. | | |
| | | | 584986 | | |
| EE5 | A1 | Check Credit | Vehicle | 2265.95 | 2020 Mar. 13 |
| | | | Purchase no. | | |
| | | | 781833 | | |
| EE6 | A1 | Check Credit | Vehicle | 3362.57 | 2020 Mar. 26 |
| | | | Purchase no. | | |
| | | | 650621 | | |
| EE7 | A1 | Check Credit | Vehicle | 12893.35 | 2020 Apr. 17 |
| | | | Purchase no. | | |
| | | | 769055 | | |
| EE8 | A1 | Check Credit | Vehicle | 7713.50 | 2020 Jun. 1 |
| | | | Purchase no. | | |
| | | | 266107 | | |
| EE9 | A1 | Check Credit | Vehicle | 10332.24 | 2020 Jun. 11 |
| | | | Purchase no. | | |
| | | | 921935 | | |
| EE10 | A1 | Check Credit | Vehicle | 6539.03 | 2020 Jun. 17 |
| | | | Purchase no. | | |
| | | | 24520 | | |
| EE11 | A1 | Check Credit | Vehicle | 145678.84 | 2020 Jun. 29 |
| | | | Purchase no. | | |
| | | | 968366 | | |
| A1 | EE13 | Check Debit | Vehicle | 3220.00 | 2020 Mar. 10 |
| | | | Auction no. | | |
| | | | 787496 | | |
| A1 | EE14 | Check Debit | Vehicle | 1670.00 | 2020 Mar. 16 |
| | | | Auction no. | | |
| | | | 46264 | | |
| A1 | EE15 | Check Debit | Vehicle | 4680.00 | 2020 Mar. 24 |
| | | | Auction no. | | |
| | | | 478612 | | |
| A1 | EE16 | Check Debit | Vehicle | 3980.00 | 2020 Mar. 31 |
| | | | Auction no. | | |
| | | | 986905 | | |
| A1 | EE17 | Check Debit | Vehicle | 2730.00 | 2020 Apr. 3 |
| | | | Auction no. | | |
| | | | 494983 | | |
| A1 | EE18 | Check Debit | Vehicle | 2470.00 | 2020 Apr. 14 |
| | | | Auction no. | | |
| | | | 937043 | | |
| A1 | EE19 | Check Debit | Vehicle | 1380.00 | 2020 Apr. 14 |
| | | | Auction no. | | |
| | | | 55119 | | |
| A1 | EE20 | Check Debit | Vehicle | 2230.00 | 2020 Apr. 15 |
| | | | Auction no. | | |
| | | | 298326 | | |
| A1 | EE21 | Check Debit | Vehicle | 4350.00 | 2020 Apr. 23 |
| | | | Auction no. | | |
| | | | 326486 | | |
| A1 | EE22 | Check Debit | Vehicle | 2940.00 | 2020 May 13 |
| | | | Auction no. | | |
| | | | 410939 | | |
| A1 | EE23 | Check Debit | Vehicle | 4640.00 | 2020 Jun. 5 |
| | | | Auction no. | | |
| | | | 278426 | | |
| A1 | EE24 | Check Debit | Vehicle | 4280.00 | 2020 Jun. 23 |
| | | | Auction no. | | |
| | | | 155206 | | |

Step outputs are shown below in Table 14. The step outputs have been modified to demonstrate how Programmatic Evaluation works. The original narrative draft included the correct value.

TABLE 14

| | | | | | Event | | |
|---|---|---|---|---|---|---|---|
| | | | | | Narrative | Event | |
| | | | | | Generation - | Narrative | |
| | | | Event Narrative | | Pattern | Generation - | |
| | | | Generation - | Event Narrative | Checking | Master | |
| | Event Narrative | Event Narrative | Master Evaluator | Generation - | Agent: | Evaluator | |
| | Generation - | Generation - | Agent: | Pattern Checking | Combine | Agent: | |
| | Generation | Pattern Detector | Programmatic | Agent: Single | single | Review | Case Report |
| Scenario | Agent | Agent | Evaluation | Evaluation | evaluations | Narrative | Generation Agent |
| HRG | This event with | {“pattern_quote”: | Wire Transfer - | Pattern: “All | N/A | N/A | This case involves |
| | the scenario | “from Country | max_transaction_{—} | wire transfers are | | | John Doe5, the |
| | ‘High Risk | CY3, a High-Risk | amount is not | from Country | | | owner of Big Auto |
| | Transactions: | Geography | mentioned in | CY3, a | | | Sales, and consists |
| | High Risk | jurisdiction”, | report, should be: | High-Risk | | | of two alerted |
| | Geography’ is | “pattern_{—} | 20015.0 | Geography | | | events: a structuring |
| | alerted on the | clarification”: | | jurisdiction.” | | | event and a high-risk |
| | basis of an AML | “All wire | | Reasoning: | | | transactions |
| | detection and | transfers are from | | The alerted | | | event. The |
| | because of four | Country CY3, a | | transactions | | | structuring event |
| | alerted wire | High-Risk | | table shows that | | | involves six cash |
| | transfers from | Geography | | all wire transfers | | | withdrawals that |
| | Country CY3, a | jurisdiction.”, | | have a country | | | appear to be |
| | High-Risk | “affected_{—} | | of origin listed | | | structured to avoid |
| | Geography | transactions”: | | as Country CY3. | | | reporting thresholds, |
| | jurisdiction. The | “multiple”} | | There are 4 wire | | | while the |
| | transactions | | | transfers in total, | | | high-risk |
| | occurred | | | and all of them | | | transactions event |
| | between March | | | have Country | | | involves wire |
| | 2020 and June | | | CY3 as the | | | transfers from a |
| | 2020, with a | | | country of origin. | | | high- risk geography |
| | total amount of | | | Correctness: | | | jurisdiction. |
| | $68,313. | | | Correct. | | | John Doe5, born on |
| | Big Auto Sales | | | No correction is | | | May 22, 1984, is the |
| | is a business | | | necessary, as the | | | owner of Big Auto |
| | deposit account | | | pattern | | | Sales, a business |
| | at Brick Bank, | | | accurately | | | located at 45678 |
| | opened on | | | reflects the data. | | | Independence |
| | Nov. 24, 2019. | {“pattern_quote”: | | Pattern: “All | N/A | | Road, Highland, OH |
| | The account is | “from John Doe7 | | wire transfers | | | 44143. He is also |
| | associated with | in Country CY3 to | | are from the | | | the customer |
| | John Doe5, a | Big Auto Sales”, | | same external | | | associated with the |
| | business owner | “pattern_{—} | | entity, John | | | business deposit |
| | born on May 22, | clarification”: | | Doe7 in Country | | | account A1 at Brick |
| | 1984, and | “All wire transfers | | CY3, to Big | | | Bank, which was |
| | residing at | are from the same | | Auto Sales.” | | | opened on |
| | 23456 Pleasant | external entity, | | Reasoning: The | | | Nov. 24, 2019. |
| | Dr, Nice City, | John Doe7 in | | alerted | | | The events in this |
| | OH 44141. The | Country CY3, to | | transactions | | | case are as follows: |
| | account's | Big Auto Sales.”, | | table shows that | | | Structuring - |
| | address is listed | “affected_{—} | | all wire transfers | | | Avoidance of |
| | as 45678 Long | transactions”: | | are from EE1 | | | Reporting |
| | Road, Highland, | “multiple”} | | (John Doe7) to | | | Thresholds: There |
| | OH 44143. | | | A1 (Big Auto | | | are six cash |
| | The alerted | | | Sales). The | | | withdrawals from the |
| | transactions are | | | country of origin | | | business deposit |
| | the following: | | | for all these | | | account A1, all |
| | Wire transfers: | | | transactions is | | | made to John Doe5. |
| | There are four | | | Country CY3. | | | The withdrawals |
| | wire transfers | | | Correctness: | | | range from $2,600 to |
| | from John Doe7 | | | Correct. No | | | $9,900, totaling |
| | in Country CY3 | | | correction is | | | $44,700. These |
| | to Big Auto | | | necessary, as the | | | transactions |
| | Sales. The | | | pattern matches | | | occurred between |
| | transfers range | | | the data exactly. | | | Feb. 13, 2020, |
| | from $12,678 to | | | | | | and Jul. 6, 2020, |
| | $18,256* and | | | | | | and were made from |
| | occurred | | | | | | different branches, |
| | between Mar. 19, | | | | | | with the majority |
| | 2020, and Jun. | | | | | | (four transactions) |
| | 23, 2020. The | | | | | | occurring at Branch |
| | total amount of | | | | | | 4567 in Cleveland, |
| | these high-risk | | | | | | OH. The alert |
| | geography | | | | | | highlights indicate |
| | transactions is | | | | | | three attempts of |
| | $68,313. The | | | | | | structuring activity, |
| | alert highlights | | | | | | suggesting a |
| | show that the | | | | | | potential attempt to |
| | High-Risk | | | | | | evade reporting |
| | Geography | | | | | | requirements. |
| | transactions | | | | | | High Risk |
| | make up 29% of | | | | | | Transactions: High |
| | the total amount | | | | | | Risk Geography: |
| | of all | | | | | | This event involves |
| | transactions. | | | | | | four wire transfers |
| Struc- | This event with | {“pattern_quote”: | All tool | Pattern: “All | **Pattern: | | from John Doe7 in |
| turing | the scenario | “all made by John | outputs were | cash withdrawals | ** “All cash | | Country CY3, a |
| | ‘Structuring - | Doe5”, “pattern_{—} | correctly used. | from the business | withdrawals | | high-risk geography |
| | Avoidance of | clarification”: | | deposit account | from the | | jurisdiction, to Big |
| | Reporting | “All cash | | A1 were made | business | | Auto Sales. The |
| | Thresholds’ is | withdrawals from | | by John Doe5.” | deposit | | transfers range from |
| | alerted on the | the business | | Reasoning: The | account | | $12,678 to $20,015 |
| | basis of an AML | deposit account | | entities table | A1 were made | | and occurred |
| | detection and | A1 were made | | shows that | by John Doe5.” | | between Mar. 19, |
| | because of 6 | by John Doe5.”, | | account A1 is | **Correctness: | | 2020, and Jun. 23, |
| | alerted cash | “affected_{—} | | associated with | ** 1 out of 5 | | 2020, totaling |
| | withdrawals | transactions”: | | Big Auto Sales, | models deem | | $68,313. The alert |
| | spanning from | “multiple”} | | and John Doe5 is | the pattern | | highlights show that |
| | February 2020 | | | the signer of | correct, while 4 | | these high-risk |
| | to July 2020 with | | | this account. | out of 5 | | geography |
| | a total amount of | | | However, the | models deem | | transactions make |
| | $44,700. John | | | table does not | it incorrect. | | up a significant |
| | Doe5, born on | | | explicitly state | Based on the | | proportion (29%) of |
| | May 22, 1984, | | | that John Doe5 | majority | | the total transaction |
| | is the owner of | | | made all the cash | response, the | | amount, which may |
| | Big Auto Sales, | | | withdrawals. The | pattern is | | warrant further |
| | a business | | | alerted | considered | | scrutiny. |
| | located at 45678 | | | transactions table | **incorrect**. | | The two events may |
| | Independence | | | only shows that | **Correction: | | be linked, as the |
| | Road, Highland, | | | the transactions | ** The | | cash withdrawals in |
| | OH 44143. The | | | were made from | corrections | | the structuring event |
| | business has a | | | account A1 to | proposed by | | could potentially be |
| | TIN of 11- | | | customer C1, | the models are | | connected to the |
| | 1111111. John | | | who is John | similar, with | | funds received from |
| | Doe5 is also the | | | Doe5. It does not | Models 1, 2, | | the high-risk |
| | customer | | | provide | and 4 | | geography |
| | associated with | | | information on | suggesting | | jurisdiction in the |
| | the account A1, | | | who actually | rephrasing | | high-risk |
| | a business | | | made the | the statement | | transactions event. |
| | deposit account | | | withdrawals. | to indicate | | Between Jan. 30, |
| | at Brick Bank. | | | Correctness: | that the | | 2020, and Jul. 20, |
| | the account | | | Incorrect. | withdrawals | | 2020, the |
| | was opened on | | | Correction: | were made | | following non- |
| | Nov. 24, 2019. | | | Replace with: | “to” John | | alerted transactions |
| | The alerted | | | “All cash | Doe5, rather | | occurred: |
| | transactions are | | | withdrawals | than “by” him. | | There were nine |
| | the following: | | | from the | Model 3 | | check credits to the |
| | Cash | | | business deposit | proposes | | business deposit |
| | withdrawals: | | | account A1 were | a slightly | | account A1, totaling |
| | There are 6 | | | made to John | different | | $68,586.34, with |
| | cash withdrawals | | | Doe5.” | rephrasing, but | | individual amounts |
| | from the business | | | [ . . . additional | the overall | | ranging from |
| | deposit account | | | evaluations . . . ] | idea is the | | $2,265.95 to |
| | A1, all made by | | | | same. | | $12,893.35. |
| | John Doe5. The | | | | Therefore, the | | These credits were |
| | withdrawals | | | | proposed | | for vehicle |
| | range from | | | | correction | | purchases, as |
| | $2,600 to | | | | is to replace | | indicated by the |
| | $9,900, with a | | | | the pattern | | transaction |
| | total amount of | | | | with: “All | | descriptions. |
| | $44,700. The | | | | cash withdrawals | | Additionally, there |
| | transactions | | | | from the | | were 12 check |
| | occurred between | | | | business | | debits from the |
| | Feb. 13, 2020, | | | | deposit | | same account, |
| | and Jul. 6, 2020. | | | | account A1 | | totaling $38,570, |
| | Notably, the | | | | were made to | | with amounts |
| | withdrawals | | | | John Doe5.” | | ranging from $1,380 |
| | were made from | | | | This revised | | to $4,680. These |
| | different | | | | statement is | | debits were for |
| | branches, with | | | | supported by | | vehicle auctions. |
| | three transactions | | | | the data and | | The non-alerted |
| | occurring at | | | | reflects the | | transactions |
| | Branch 4567 in | | | | majority | | suggest regular |
| | Cleveland, OH | | | | consensus | | business activity for |
| | 44142, one at | | | | among the | | Big Auto Sales, with |
| | Branch 5678 in | | | | models. | | both vehicle |
| | Buffalo, NY | {“pattern_quote”: | | Pattern: “The | Here is the | | purchases and |
| | 14203, and one | “with three | | cash withdrawals | output: Pattern: | | sales. |
| | at Branch 6789 | transactions | | occurred at | “The cash | | |
| | in Indianapolis, | occurring at | | different | withdrawals | | |
| | IN 46107. The | Branch 4567 in | | branches, | occurred | | |
| | alert highlights | Cleveland, OH | | specifically three | at different | | |
| | show that there | 44142, one at | | at Branch 4567 | branches, | | |
| | were 3 attempts | Branch 5678 in | | in Cleveland, | specifically | | |
| | of structuring | Buffalo, NY | | OH 44142, one | three at Branch | | |
| | activity. | 14203, and one at | | at Branch 5678 | 4567 in | | |
| | | Branch 6789 in | | in Buffalo, NY | Cleveland, OH | | |
| | | Indianapolis, | | 14203, and one | 44142, one at | | |
| | | IN 46107”, | | at Branch 6789 | Branch 5678 in | | |
| | | “pattern_{—} | | in Indianapolis, | Buffalo, NY | | |
| | | clarification”: | | IN 46107.” | 14203, and one | | |
| | | “The cash | | Reasoning: | at Branch | | |
| | | withdrawals | | The alerted | 6789 in | | |
| | | occurred at | | transactions | Indianapolis, | | |
| | | different branches, | | table shows that | IN 46107.” | | |
| | | specifically three | | there are indeed | Correctness: | | |
| | | at Branch 4567 in | | cash withdrawals | 0 out of 5 | | |
| | | Cleveland, OH | | at different | models deem | | |
| | | 44142, one at | | branches. | the pattern | | |
| | | Branch 5678 in | | However, upon | correct, while | | |
| | | Buffalo, NY | | closer inspection, | 5 out of 5 | | |
| | | 14203, and one at | | we can see that | models deem | | |
| | | Branch 6789 in | | there are actually | it incorrect. | | |
| | | Indianapolis, | | four transactions | Based on the | | |
| | | IN 46107.”, | | at Branch 4567 | majority | | |
| | | “affected_{—} | | in Cleveland, | response, | | |
| | | transactions”: | | OH 44142 (on | the pattern | | |
| | | “multiple”} | | 2020 Feb. 13, | is deemed | | |
| | | | | 2020 Apr. 4, | incorrect. | | |
| | | | | 2020 Jun. 13, | Correction: | | |
| | | | | and 2020 Jul. 6), | Since all | | |
| | | | | one at Branch | models agree | | |
| | | | | 5678 in Buffalo, | on the | | |
| | | | | NY 14203 (on | correction, the | | |
| | | | | 2020 Feb. 14), | corrected | | |
| | | | | and one at | pattern | | |
| | | | | Branch 6789 in | should be: | | |
| | | | | Indianapolis, | “The cash | | |
| | | | | IN 46107 (on | withdrawals | | |
| | | | | 2020 Apr. 5). | occurred | | |
| | | | | Correctness: | at different | | |
| | | | | Incorrect. | branches, | | |
| | | | | Correction: | specifically | | |
| | | | | Replace with: | four at Branch | | |
| | | | | “The cash | 4567 in | | |
| | | | | withdrawals | Cleveland, OH | | |
| | | | | occurred | 44142, one at | | |
| | | | | at different | Branch 5678 in | | |
| | | | | branches, | Buffalo, NY | | |
| | | | | specifically | 14203, and one | | |
| | | | | four at | at Branch | | |
| | | | | Branch 4567 in | 6789 in | | |
| | | | | Cleveland OH | Indianapolis, | | |
| | | | | 44142, one at | IN 46107.” | | |
| | | | | Branch 5678 in | | | |
| | | | | Buffalo, NY | | | |
| | | | | 14203,and one | | | |
| | | | | at Branch 6789 | | | |
| | | | | in Indianapolis, | | | |
| | | | | IN 46107.” | | | |
| | | | | [ . . . additional | | | |
| | | | | evaluations . . . ] | | | |

### Cloud or Enterprise Embodiments

In one embodiment, the present system (such as narrative generation system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, narrative generation system 100 is a centralized server-side application that provides at least the functions disclosed herein and that is accessed by many users by way of computing devices/terminals communicating with the computers of narrative generation system 100 (functioning as one or more servers) over a computer network. In one embodiment narrative generation system 100 may be implemented by a server or other computing device configured with hardware and software to implement the functions and features described herein.

In one embodiment, the components of narrative generation system 100 may be implemented as sets of one or more software modules executed by one or more computing devices specially configured for such execution. In one embodiment, the components of narrative generation system 100 are implemented on one or more hardware computing devices or hosts interconnected by a data network. For example, the components of narrative generation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of narrative generation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of narrative generation system 100 may (i) generate or compose an electronic message or signal to issue a command or request to another component, (ii) transmit the message or signal to other components of narrative generation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by narrative generation system 100, for example through a web interface server. In one embodiment, the remote computing system may send requests to and receive responses from narrative generation system 100. In one example, access to the information or applications may be effected through use of a web browser on a personal computer or mobile device. In one example, communications exchanged with narrative generation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of narrative generation system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, narrative generation systems and methods described herein may be implemented by using a computer program product, comprising computer program/instructions which, when executed by a processor, cause the processor to perform any of the methods described in the disclosure.

### Computing Device Embodiment

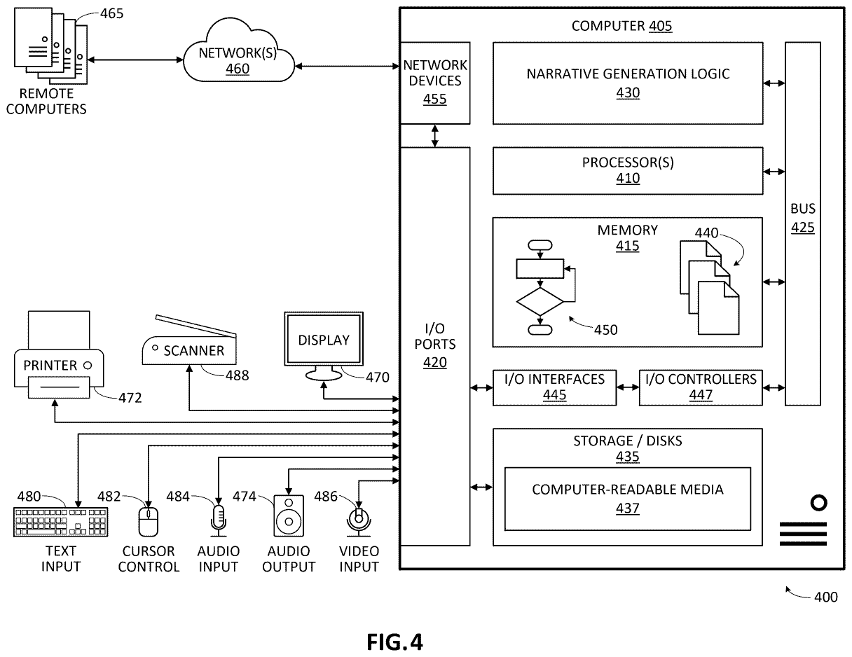

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include narrative generation logic 430 configured to facilitate automated case narrative generation for monitoring systems similar to the logic, systems, methods, and other embodiments shown in and described with reference to FIGS. 1, 2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate automated case narrative generation for monitoring systems. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
generate, by a generation agent executed by the computing system, an event narrative draft based at least in part on case data associated with alerted interactions from a monitoring system, wherein the case data includes interaction records, alert highlights, and entity information;
parse, by a pattern detector agent executed by the computing system, the event narrative draft to automatically identify one or more candidate statements that aggregate or generalize the case data in the event narrative draft;
distribute, by a master evaluator agent executed by the computing system, the one or more candidate statements to one or more pattern checking agents that correspond to the one or more patterns for evaluation for correctness;
execute, by the one or more pattern checking agents executed by the computing system, a programmatic validation of individual candidate statements against the interaction records to classify the individual candidate statements as consistent with or inconsistent with the interaction records; and
combine, by the master evaluator agent executed by the computing system, the validated statements from the one or more pattern checking agents into a final event narrative based on the corrected statements, wherein the final event narrative exhibits improved factual reliability relative to the event narrative draft.

2. The non-transitory computer-readable medium of claim 1, further comprising instructions that when executed by at least the processor cause the computing system to combine, by a case report generation agent, the final event narrative with a plurality of other final event narratives into a case report providing a machine-generated explanation of system alerts.

3. The non-transitory computer-readable medium of claim 1, wherein the interactions monitored by the interaction monitoring system are one of financial transactions, computer security event, clinical event, sensor event, grid event, call detail record, or package scan or location event.

4. The non-transitory computer-readable medium of claim 1, further comprising instructions that when executed by at least the processor cause the computing system to:
generate, using a deterministic auxiliary tool executed by the processor, analytics of the case data;
exclude, by the generation agent, the analytics output from the deterministic auxiliary tool from the candidate statements; and
verify inclusion of the analytics in the final event narrative.

5. The non-transitory computer-readable medium of claim 1, wherein the instructions for distributing the one or more candidate statements to one or more pattern checking agents when executed by at least the processor further cause the master evaluator agent to transmit the one or more candidate statements to a plurality of pattern checking agents operating in parallel.

6. The non-transitory computer-readable medium of claim 1, wherein the majority voting procedure further causes the computing system to execute additional evaluations of candidate statements classified as incorrect and apply majority voting to the additional evaluations.

7. The non-transitory computer-readable medium of claim 1, wherein an LLM used by one of the pattern detector agent, master evaluator agent, and pattern checking agents has model parameters that are distinct from a LLM used by the generation agent, wherein the model parameters include a temperature setting that is higher than that used by the generation agent.

8. A computer-implemented method, comprising:
generating, by a generation agent executed by the computing system, an event narrative draft based at least in part on case data associated with alerted interactions from a monitoring system, wherein the case data includes interaction records, alert highlights, and entity information;
parsing, by a pattern detector agent executed by the computing system, the event narrative draft to automatically identify one or more candidate statements that aggregate or generalize the case data in the event narrative draft;
distributing, by a master evaluator agent executed by the computing system, the one or more candidate statements to one or more pattern checking agents that correspond to the one or more patterns for evaluation for correctness;
executing, by the one or more pattern checking agents executed by the computing system, a programmatic validation of individual candidate statements against the interaction records to classify the individual candidate statements as consistent with or inconsistent with the interaction records; and
combining, by the master evaluator agent executed by the computing system, the validated statements from the one or more pattern checking agents into a final event narrative based on the corrected statements.

9. The computer-implemented method of claim 8, further comprising:
combining, by a case report generation agent, the final event narrative with a plurality of other final event narratives into a case report that provides a machine-generated explanation of system alerts; and
including in the case report additional non-alerted interactions associated with the entity.

10. The computer-implemented method of claim 8, further comprising: wherein the interactions monitored by the interaction monitoring system are financial transactions.

11. The computer-implemented method of claim 8, further comprising:
generating, using a deterministic auxiliary tool executed by the processor, analytics of the case data;
excluding, by the generation agent, analytics output from the deterministic auxiliary tool from the candidate statements; and
verifying inclusion of the analytics in the final event narrative.

12. The computer-implemented method of claim 8, wherein the distributing the one or more candidate statements to the one or more pattern checking agents further comprises transmitting, by the master evaluator agent, the one or more candidate statements to a plurality of pattern checking agents operating in parallel.

13. The computer-implemented method of claim 8, wherein the majority voting procedure further comprises executing additional evaluations of candidate statements classified as incorrect and applying majority voting to the additional evaluations.

14. The computer-implemented method of claim 8, wherein an LLM used by one of the pattern detector agent, master evaluator agent, and pattern checking agents has model parameters that are distinct from a LLM used by the generation agent.

15. A computing system, comprising:
one or more computing devices operably connected to communicate over one or more communication networks via one or more network interfaces;
at least one processor connected to at least one memory, wherein the at least one processor is operably connected to at least one of the one or more computing devices; and
one or more non-transitory computer readable media including instructions stored thereon that when executed by at least the computing system cause the processor to:
generate, by a generation agent executed by the computing system, an event narrative draft based at least in part on case data associated with alerted interactions from a monitoring system, wherein the case data includes interaction records, alert highlights, and entity information;
parse, by a pattern detector agent executed by the computing system, the event narrative draft to automatically identify one or more candidate statements that aggregate or generalize the case data in the event narrative draft;
distribute, by a master evaluator agent executed by the computing system, the one or more candidate statements to one or more pattern checking agents that correspond to the one or more patterns for evaluation for correctness;
execute, by the one or more pattern checking agents executed by the computing system, a programmatic comparison of individual candidate statements against the interaction records to classify the individual candidate statements as consistent with or inconsistent with the interaction records; and
combining, by the master evaluator agent executed by the computing system, the validated statements from the one or more pattern checking agents into a final event narrative based on the corrected statements.

16. The computing system of claim 15, wherein the instructions when executed by at least the processor further cause the computing system to combine, by a case report generation agent, the final event narrative with a plurality of other final event narratives into a case report providing a machine-generated explanation of system alerts.

17. The computing system of claim 15, wherein the interactions monitored by the interaction monitoring system are computer security events.

18. The computing system of claim 15, wherein the instructions when executed by at least the processor further cause the computing system to:
generate, using a deterministic auxiliary tool executed by the processor, analytics of the case data;
exclude, by the generation agent, analytics output from the deterministic auxiliary tool from the candidate statements; and
verify inclusion of the analytics in the final event narrative.

19. The computing system of claim 15, wherein the instructions when executed by at least the processor further cause the computing system to execute the plurality of pattern checking agents in parallel.

20. The computing system of claim 15, wherein an LLM used by one of the pattern detector agent, master evaluator agent, and pattern checking agents has a temperature setting that is higher than a LLM used by the generation agent.
